(19) United States
(12) Patent Application Publication
(10) Pub. No.: US 2023/0259577 A1
(43) Pub. Date: Aug. 17, 2023

(54) COMPUTATION APPARATUS AND COMPUTATION METHOD THEREFOR

(71) Applicant: NEC Corporation, Tokyo (JP)

(72) Inventor: Yuki Susa, Tokyo (JP)

(73) Assignee: NEC Corporation, Tokyo (JP)

(21) Appl. No.: 18/105,486

(22) Filed: Feb. 3, 2023

(30) Foreign Application Priority Data
Feb. 15, 2022 (JP) 2022-021151

(51) Int. Cl. G06F 17/11

(52) U.S. Cl. CPC G06F 17/11

(57) ABSTRACT

A computation apparatus includes a coefficient setting unit configured to set, in a value of an objective function including a performance indicator representing performance of each candidate solution and a constraint indicator representing a degree of each candidate solution satisfying a constraint condition, a value of a coefficient for adjusting a degree of impact between a value of the performance indicator and a value of the constraint indicator according to a value of the performance indicator related to a first candidate solution satisfying the constraint condition, a value of the performance indicator related to a second candidate solution unsatisfying the constraint condition, and a value of the constraint indicator, and a solution acquisition unit configured to search for a solution to a problem to be solved using the objective function which the value of the coefficient is set to.

### CROSS-REFERENCE TO RELATED APPLICATION

The present application claims the priority benefit of Japanese Patent Application No. 2022-21151 filed on Feb. 15, 2022, the subject matter of which is incorporated herein by reference.

### BACKGROUND OF THE INVENTION

### 1. Field of the Invention

The present invention relates to a computation apparatus and a computation method.

### 2. Description of Related Art

Quantum annealing is a meta-heuristic optimization method using superposition of quantum mechanics. Simulated annealing such as quantum annealing is set to have a Hamiltonian using a single formula concluding an objective function and a constraint condition in a constrained optimization problem restricted by a constraint condition to be solved, wherein a solution will be produced to reduce a Hamiltonian value as small as possible.

Various documents have been published with respect to quantum computation. For example, Patent Document 1 discloses an integer programming device configured to accurately produce a solution to a constrained integer programming problem using an annealing machine. Specifically, Patent Document 1 teaches the Hamiltonian representing a constraint condition using a linear equality and a linear inequality, updating a coefficient value of a constrained-inequality term via the Hamiltonian according to an expected value of the constrained-inequality term, and updating a coefficient value of a constrained-equality term according to a parameter constant.

Patent Document 2 discloses an optimization system configured to efficiently produce a solution to a set partitioning problem using a hybrid system properly using a general-purpose computer and a quantum computer such as a quantum-annealing machine using superconducting qubits. Patent Document 3 discloses a quantum computer using qubits reflecting spins in semiconductors and metals, in particular, applied to spinning structures combined with DNA base sequences. Patent Document 4 discloses a combinatorial optimization problem to be solved by simulated annealing.

In the Hamiltonian, it is possible to perform a solution search using an objective function including a performance indicator representing a performance of a candidate solution and a constraint indicator representing a degree of a candidate solution to satisfy a constraint condition. A degree of impact between a performance-indicator value and a constraint-indicator value in the objective function may affect a time length needed for solution search and accuracy to produce solutions. When a constraint condition includes a higher order of equality such as a quadratic equality or a higher order of inequality such as a quadratic inequality, it is preferable that a degree of impact between a performance-indicator value and a constraint-indicator value be adjusted in order to realize a relatively high likelihood of producing an optimum solution.

None of Patent Document 1 through Patent Document 4 may contribute to the aforementioned problem. The present invention aims to provide a computation apparatus and a computation method which can solve the aforementioned problem.

### 3. Patent Documents

Patent Document 1: Japanese Patent Application Publication No. 2021-89596
Patent Document 2: Japanese Patent Application Publication No. 2021-43693
Patent Document 3: Japanese Patent Application Publication No. 2005-93511
Patent Document 4: Japanese Patent Application Publication No. H09-34951

### SUMMARY OF THE INVENTION

In a first aspect of the present invention, a computation apparatus includes a coefficient setting unit configured to set, in a value of an objective function including a performance indicator representing performance of each candidate solution and a constraint indicator representing a degree of each candidate solution satisfying a constraint condition, a value of a coefficient for adjusting a degree of impact between a value of the performance indicator and a value of the constraint indicator according to a value of the performance indicator related to a first candidate solution satisfying the constraint condition, a value of the performance indicator related to a second candidate solution unsatisfying the constraint condition, and a value of the constraint indicator, and a solution acquisition unit configured to search for a solution to a problem to be solved using the objective function which the value of the coefficient is set to.

In a second aspect of the present invention, a computation method includes the steps of: setting, in a value of an objective function including a performance indicator representing performance of each candidate solution and a constraint indicator representing a degree of each candidate solution satisfying a constraint condition, a value of a coefficient for adjusting a degree of impact between a value of the performance indicator and a value of the constraint indicator according to a value of the performance indicator related to a first candidate solution satisfying the constraint condition, a value of the performance indicator related to a second candidate solution unsatisfying the constraint condition, and a value of the constraint indicator; and searching for a solution to a problem to be solved using the objective function which the value of the coefficient is set to.

In a third aspect of the present invention, a non-transitory computer-readable storage medium is configured to store a program causing a computation apparatus to: set, in a value of an objective function including a performance indicator representing performance of each candidate solution and a constraint indicator representing a degree of each candidate solution satisfying a constraint condition, a value of a coefficient for adjusting a degree of impact between a value of the performance indicator and a value of the constraint indicator according to a value of the performance indicator related to a first candidate solution satisfying the constraint condition, a value of the performance indicator related to a second candidate solution unsatisfying the constraint condition, and a value of the constraint indicator; and search for a solution to a problem to be solved using the objective function which the value of the coefficient is set to.

According to the present invention, it is possible to adjust a degree of impact between the value of the performance indicator and the value of the constraint indicator so as to increase a probability of obtaining the optimum solution even when the constraint condition includes a higher order of equality such as a quadratic equality or a higher order of inequality such as a quadratic inequality and even when it is difficult to calculate an expected value for a certain term of the constraint condition.

### BRIEF DESCRIPTION OF THE DRAWINGS

FIG. 1 is a block diagram showing a configuration example of a computation apparatus according to the exemplary embodiment of the present invention.

FIG. 2 is a schematic illustration showing an example of an LHZ model.

FIG. 3 is a flowchart showing a procedure example to produce a solution with the computational apparatus according to the exemplary embodiment of the present invention.

FIG. 4 is a flowchart showing a procedure example of a minimum-candidate-updating process according to the exemplary embodiment of the present invention.

FIG. 5 is a graph showing an example of the relationship between a probability of producing a candidate solution satisfying a constraint condition and a probability of successfully producing an optimum solution according to the exemplary embodiment of the present invention.

FIG. 6 is a graph showing a first example of distribution of values to be produced by an objective function with respect to candidate solutions satisfying constraint conditions and candidate solutions unsatisfying constraint conditions according to the exemplary embodiment of the present invention.

FIG. 7 is a graph showing a second example of distribution of values to be produced by an objective function with respect to candidate solutions satisfying constraint conditions and candidate solutions unsatisfying constraint conditions according to the exemplary embodiment of the present invention.

FIG. 8 is a graph showing a third example of distribution of values to be produced by an objective function with respect to candidate solutions satisfying constraint conditions and candidate solutions unsatisfying constraint conditions according to the exemplary embodiment of the present invention.

FIG. 9 is a graph showing a fourth example of distribution of values to be produced by an objective function with respect to candidate solutions satisfying constraint conditions and candidate solutions unsatisfying constraint conditions according to the exemplary embodiment of the present invention.

FIG. 10 is a graph showing a first example of distribution of values to be produced by an objective function before updating the value of a constrained weight with a coefficient setting unit according to the exemplary embodiment of the present invention.

FIG. 11 is a graph showing a first example of distribution of values to be produced by an objective function after updating the value of a constrained weight with a coefficient setting unit according to the exemplary embodiment of the present invention.

FIG. 12 is a graph showing a second example of distribution of values to be produced by the objective function before updating the value of the constrained weight with the coefficient setting unit according to the exemplary embodiment of the present invention.

FIG. 13 is a graph showing a second example of distribution of values to be produced by the objective function after updating the value of the constrained weight with the coefficient setting unit according to the exemplary embodiment of the present invention.

FIG. 14 is a graph showing an example of the relationship between the number of times for updating the value of the constrained weight and the value of the constrained weight according to the exemplary embodiment of the present invention.

FIG. 15 is a graph showing an example of the relationship between the number of times for updating the value of the constrained weight and the minimum value of the objective function to be produced using candidate solutions satisfying the constraint condition according to the exemplary embodiment of the present invention.

FIG. 16 is a graph showing comparative examples of optimum-solution acquisition rates according to the exemplary embodiment of the present invention.

FIG. 17 is a graph showing comparative examples of total traveling distances related to solutions of the traveling salesman problem according to the exemplary embodiment of the present invention.

FIG. 18 is a block diagram showing a configuration example of a control system according to the exemplary embodiment of the present invention.

FIG. 19 is a block diagram showing a computation apparatus having a minimum configuration according to the exemplary embodiment of the present invention.

FIG. 20 is a flowchart showing a procedure example of the computation apparatus shown in FIG. 19.

FIG. 21 is a block diagram showing a hardware configuration of a computer realizing the exemplary embodiment of the present invention.

### DETAILED DESCRIPTION OF THE EXEMPLARY EMBODIMENTS

The present invention will be described in detail by way of examples and embodiments, which are descriptive and not restrictive to the scope of the invention as defined by the appended claims. It is to be noted that any combinations of features explained in the exemplary embodiments are not necessarily essential to the technical solutions of the present embodiment.

FIG. 1 is a block diagram showing a configuration example of a computation apparatus 100 according to the exemplary embodiment of the present invention. The computation apparatus 100 includes a solution acquisition unit 120 and an input/output unit 130. The computation apparatus 100 is configured to produce a solution to a constrained optimization problem. Solving a constrained optimization problem refers to producing a solution using variables satisfying constraint conditions and achieving as high a performance as possible. Herein, an operation to produce a solution is not necessarily limited to an operation of deductively producing a solution via a formula or the like. In particular, the computation apparatus 100 may produce a solution according to a heuristic method.

It is possible to provide a plurality of variables used for producing a solution. Therefore, solving a constrained optimization problem may refer to producing a solution using vector variables satisfying constraint conditions and achieving as high a performance as possible.

Generally, a solution to be produced by solving a constrained optimization problem may not necessarily be an optimum solution, which should satisfy constraint conditions and achieve the highest performance.

The computation apparatus 100 acquires a plurality of candidate solutions so as to selectively output a candidate solution, which satisfies constraint conditions and achieves the highest performance indicated by the objective function, as a solution to a constrained optimization problem. However, the computation apparatus 100 may acquire candidate solutions using variables unsatisfying constraint conditions.

The following descriptions refer to the computation apparatus 100 configured to produce a solution according to a quantum-annealing method. Using an objective function H according to formula (1), the computation apparatus 100 may reduce a value of energy indicated by the objective function such that quantum states will be identified from superposed states of quantum candidates (e.g., states to be taken by quanta), thus acquiring candidate solutions based on quantum states.

[Formula 1]

H({σᵢ},C)=Hₚ({σᵢ})+CH_{c}({σᵢ}) (1)

In the above, a first time of annealing refers to a process of reducing a value of energy to identify any state of quantum candidates from superposed states of quantum candidates. The computation apparatus 100 will produce one candidate solution in the first time of annealing.

The objective function H will be set responsive to a problem to be solved by the computation apparatus 100. In this connection, the objective function H is referred to as a Hamiltonian H.

A symbol “i” is an integer for identifying an Ising variable (e.g., a variable indicating a quantum state, wherein σᵢ belongs to number i of an Ising variable or a value indicated by an Ising variable. After completion of the first time of annealing, the Ising variable σᵢ will take any one of “−1” and “+1”. At the start of the first time of annealing, the Ising variable σᵢ will take a superposed value of “−1” and “+1”, which will be denoted as “±1”.

The term “σᵢ” represents a candidate solution, which will be simply referred to as a candidate. It is possible to substitute a variable xᵢ for the Ising variable αᵢ, wherein the variable xᵢ is defined as a variable which may take “−1”, “+1”, or a superposed value of “−1” and “+1”.

The function Hₚ is a function representing performance of a candidate solution {σᵢ}. Specifically, the function Hₚ inputs an argument such as a candidate solution {σᵢ} and outputs its function value such as an indicator value (e.g., a performance-indicator value) representing a performance of the candidate solution {σᵢ}. The function Hₚ can be alternatively referred to as a performance function Hₚ serving as an example of a performance indicator. Herein, the performance indicator is an indicator representing a performance of a candidate solution. As the performance function Hₚ, the present exemplary embodiment uses a function whose function value will be reduced as a performance of a candidate solution {αᵢ} becomes higher. The computation apparatus 100 is configured to produce a solution for reducing the value of the objective function including the performance function Hₚ as much as possible.

A function H_{c} is a function representing a degree of the candidate solution {σᵢ} satisfying a constraint condition. Specifically, the function H_{c} inputs an argument such as a candidate solution {αᵢ} and outputs a function value as an indicator value (or a constraint-indicator value) representing a degree of the candidate solution {αᵢ} satisfying a constraint condition. The function can be alternatively referred to as a constraint function serving as an example of a constraint indicator. Herein, the constraint indicator is an indicator representing a degree of a candidate solution satisfying a constraint condition.

Assume the performance function Hₚ as a function whose function value will be reduced as a performance of the candidate solution {αᵢ} becomes higher. In this case, it is possible to use the constraint function as a function whose function value becomes smaller when the candidate solution {αᵢ} satisfies a constraint condition than when the candidate solution {αᵢ} does not satisfy a constraint condition.

The following descriptions refer to an example of the constraint function H_{c} whose function value is set to zero when the candidate solution {αᵢ} satisfies a constraint condition but whose function value becomes greater than zero when the candidate solution {αᵢ} does not satisfy a constraint condition. In this case, the computation apparatus 100 is configured to produce a solution in which the function value of the constraint function is set to zero while the value of the objective function H will become as small as possible.

The following descriptions refer to an example of the performance function Hₚ and an example of the constraint function H_{c} with respect to the computation apparatus 100 configured to solve a traveling salesman problem and the computation apparatus 100 configured to perform quantum annealing using an LHZ model (where LHZ stands for “Lechner, Hauke, and Zoller”).

The traveling salesman problem can be defined as a problem as to how to detect a pathway minimizing a traveling distance among circulating pathways each allowing a salesman to travel around all cities at once and to return to a departure city. Formula (2) shows the performance function Hₚ for the computation apparatus 100 to solve the traveling salesman problem.

$${H}_{p} = {\sum }_{t = 1}^{n} {\sum }_{a = 1}^{n} {\sum }_{b = 1}^{n} {d}_{a , b} {x}_{t , a} {x}_{t + 1 , b} \qquad ( 2 )$$

In Formula (2), a symbol “n” is an integer representing the number of cities a salesman should travel around, wherein all cities are identified by identification numbers using integers ranging from “1” to “n”. A symbol “t” is an integer within representing time steps as a time system. In Formula (2), a salesman may travel around a single city for each time (or for each time step), and then a salesman should return to the departure city at time n+1. The departure city is a city in which a salesman stays at time 1 for departure.

A variable “x_{t,a}” indicates whether or not a salesman stays in city-a at time t. The term “x_{t,a}=1” indicates that a salesman stays in city-a at time t while the term “x_{t,a}=0” indicates that a salesman does not stay in city-a at time t. In addition, a variable “d_{a,b}” represents a distance of a pathway connected between city-a and city-b. The performance function Hₚ indicates a total distance of pathways along which a salesman has traveled around.

Formula (3) shows the constraint function H_{c} for the computation apparatus 100 to solve the traveling salesman problem.

$${H}_{c} = {\sum }_{t = 1}^{n} {( {\sum }_{a = 1}^{n} {x}_{t , a} - 1 )}^{2} + {\sum }_{a = 1}^{n} {( {\sum }_{t = 1}^{n} {x}_{t , a} - 1 )}^{2} \qquad ( 3 )$$

In Formula (3), the term “Σₜ₌₁ⁿ(Σₐ₌₁ⁿx_{t,a}−1)²” is a constraint function representing a constraint condition requiring a salesman not to stay in multiple cities at the same time. When x_{t,a} refers to a single city as city-a at time t, the value of “(Σₐ₌₁ⁿx_{t,a}−1)²” becomes zero. On the other hand, when x_{t,a} refers to multiple cities as city-a at time t, the value of “(Σₐ₌₁ⁿx_{t,a}−1)²” becomes one or more. Therefore, when the variable x_{t,a} is set in such a way that a salesman should stay in a single city at each time, the value of “(Σₐ₌₁ⁿx_{t,a}−1)²” becomes zero. In contrast, when the variable x_{t,a} is set in such a way that a salesman may stay in multiple cities at a certain time, the value of “(Σₐ₌₁ⁿx_{t,a}−1)²” becomes one or more. When the variable x_{t,a} is set in such a way that a salesman does not stay in any city at a certain time, the value of “(Σₐ₌₁ⁿx_{t,a}−1)²” becomes one or more.

In Formula (3), the term “(Σₐ₌₁ⁿx_{t,a}−1)²” is a constraint function representing a constraint condition requiring a salesman not to visit the same city except for an instance in which a salesman returns to the departure city at time t=n+1. When a single time among time t=1 through time t=n may meet x_{t,a}=1 with respect to city-a, the value of “(Σₐ₌₁ⁿx_{t,a}−1)²” becomes zero. When multiple times among time t=1 through time t=n may meet x_{t,a}=1 with respect to city-a, the value of “(Σₐ₌₁ⁿx_{t,a}−1)²” becomes one or more.

Therefore, when the variable x_{t,a} is set in such a way that a salesman should visit each city once in a period from time t=1 to time t=n, the value of “(Σₐ₌₁ⁿx_{t,a}−1)²” becomes zero. On the other hand, when the variable x_{t,a} is set in such a way that a salesman may visit one city multiple times in a period from time t=1 to time t=n, the value of “(Σₐ₌₁ⁿx_{t,a}−1)²” becomes one or more. Even when the variable x_{t,a} is set in such a way that a salesman does not visit any city in a period from time t=1 to time t=n, the value of “(Σₐ₌₁ⁿx_{t,a}−1)²” becomes one or more.

Upon establishing both a constraint condition that a salesman cannot stay in multiple cities at the same time and a constraint condition that a salesman should not visit the same city multiple times except for an instance in which the salesman returns to the departure city at time t=n+1, the value of the constraint function in Formula (3) becomes zero. When any one constraint condition or both constraint conditions cannot be established, the value of the constraint function H_{c} in Formula (3) becomes greater than zero.

The LHZ model is a model for deploying qubits using a quantum-annealing machine.

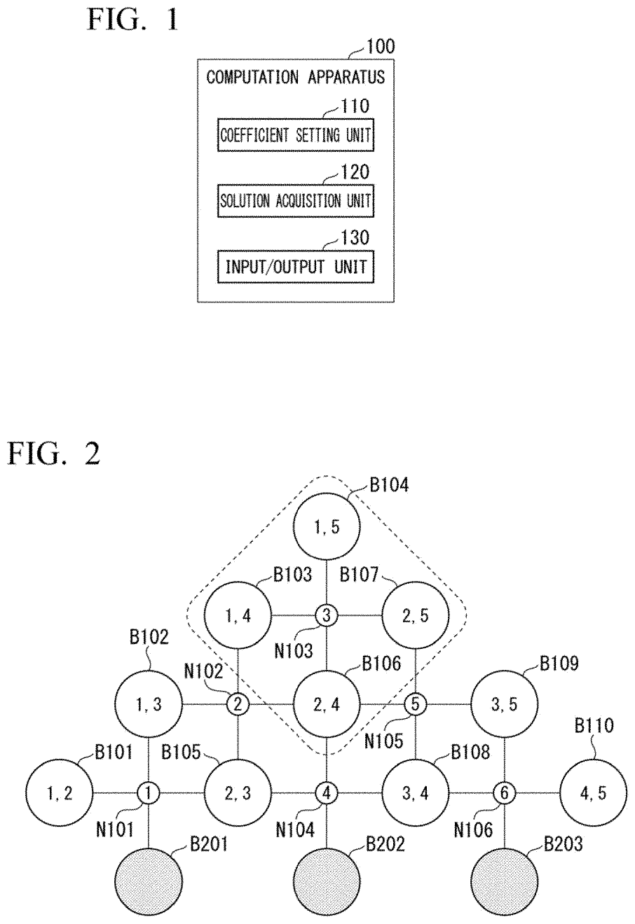

FIG. 2 shows an example of the LHZ model indicating qubits B101-B110 and qubits B201-B203, wherein a line segment laid between qubits indicate correlation between adjacent qubits. In addition, nodes N101-N106 indicate intersections at which line segments between qubits cross each other.

The qubits B101-B104 are denoted by identification numbers of qubits ranging from “1,2” to “1,5”, the qubits B105-B107 are denoted by identification numbers of qubits ranging from “2,3” to “2,5”, the qubits B108-B109 are denoted by identification numbers of qubits ranging from “3,4” to “3,5”, and the qubit B110 is denoted by an identification number “4,5”. The nodes N101 through N106 are denoted by identification numbers of nodes ranging from “1” to “6”. Formula (4) represents the performance function Hₚ when the computation apparatus 100 performs quantum annealing using the LHZ model.

$${H}_{p} = - {\sum }_{k = 1}^{K} {J}_{k} {σ}_{k} \qquad ( 4 )$$

In Formula (4), a symbol K represents the number of qubits. In FIG. 2, the qubits B101-B110 are evaluated by the performance function Hₚ of Formula (4), where K=10. A symbol k is an integer within 1≤k≤K representing an identification number for identifying each qubit. The qubits B101-B110 are each annotated with another identification number using a single integer in addition to the identification numbers shown in FIG. 2. Specifically, the qubits B101-B110 may be identified by other qubit-identification numbers ranging from “1” to “10” as well.

The term αₖ is an Ising variable representing the state of a qubit identified by identification number k. Herein, the value of the Ising variable representing the state of a qubit will be referred to as a qubit value. The coefficient Jₖ is a coefficient for each Ising variable αₖ, which is set responsive to a problem to be solved. Formula (5) shows the constraint function H_{c} when the computation apparatus 100 performs quantum annealing using the LHZ model.

$${H}_{c} = - {\sum }_{l = 1}^{L} σ ( l , n ) σ ( l , s ) σ ( l , e ) σ ( l , w ) + L \qquad ( 5 )$$

In Formula (5), a symbol L represents the number of nodes, e.g., L=6 in FIG. 2. A symbol l is an integer within 1≤l≤L, representing a node-identification number. In addition, symbols n, s, e, w represent directions in upper, lower, right, and left sides of a drawing. In Formula (5), terms “σ(l,n)”, “σ(l,s)”, “σ(l,e)”, “σ(l,w)” are four Ising variables representing the states of four qubits connected together via line segments as illustrated by a box encompassed by dotted lines. When 1=3, for example, the terms “σ(l,n)”, “σ(l,s)”, “σ(l,e)”, “σ(l,w)” are Ising variables σ₄, σ₆, σ₇, σ₃ representing the states of the qubits B104, B106, B107, B103.

The LHZ model has a constraint condition that the product of four qubits connected together via line segments should be equal to “1”; hence, the constraint condition will be referred to as 4-body correlation. For example, the four qubits B104, B106, B107, B103 connected to the node B103 via line segments should be constrained by a constraint condition that the product of those qubits should be “1”, i.e., σ₄ σ₆ σ₇ σ₃=1 according to 4-body correlation.

In FIG. 2, the qubits B101-B110 are subjected to the constrained condition of the LHZ model. Herein, the 4-body correlation is calculated with respect to the values of qubits subjected to the constraint condition among qubits connected to a certain node via line segments. Among four qubits B101, B102, B105, B201, for example, the qubits B101, B102, and B105 are subjected to the constraint condition of the LHZ model. Therefore, the constraint condition according to 4-body correlation when l=1 can be represented by σ₁σ₂σ₅=1.

It can be said that the symbol L representing the number of nodes may represent the combination of qubits related to each other according to 4-body correlation. In Formula (5), the term “+L” is a constant term for setting the minimum value of the constraint function H_{c} to zero.

The constraint condition of the LHZ model shown in FIG. 2 indicates the product “1” when multiplying three or four qubits included in all the combinations of qubits related to each other according to 4-body correlation. Upon establishing the constraint condition, the value of the constraint function H_{c} of Formula (5) would be zero. Upon failing to establish the constraint condition, the constraint function H_{c} of Formula (5) becomes greater than zero.

The coefficient C of Formula (1) is a weight coefficient for weighting the value of the constraint function H_{c}. The coefficient C is an example of a coefficient for adjusting the degree of impact between the performance-indicator value and the constraint-indicator value. Herein, the coefficient C will be referred to as a constrained weight C.

The constrained weight C is set to a value equal to or more than zero (i.e., C≥0) when the performance function Hₚ is a function to reduce its function value as the performance of the candidate solution {αᵢ} becomes higher while the constraint function Hₑ reduces its function value when the candidate solution {αᵢ} satisfies the constraint condition than when the candidate solution {αᵢ} does not satisfy the constraint condition.

In this connection, a method for the computation apparatus 100 to produce solutions is not necessarily limited to the quantum-annealing method. As the method for the computation apparatus 100 to produce solutions, it is possible to use various methods for acquiring candidate solutions using the objective function including the performance indicator, the constraint indicator and the coefficient for adjusting the performance-indicator value and the constraint-indicator value.

For example, the computation apparatus 100 may produce solutions using the simulated annealing instead of the quantum annealing.

Alternatively, the computation apparatus 100 may use the objective function of Formula (1) as the objective function of an unconstrained optimization problem to perform a solution search, thus acquiring candidate solutions to an optimization problem having its constraint condition to be solved. As the unconstrained optimization problem for the computation apparatus 100 to perform a solution search, it is possible to use the known solution search method.

As the performance function Hₚ, it is possible to use a function to increase its function value as the performance of the candidate solution {αᵢ} becomes higher. In this case, the computation apparatus 100 may produce a solution in which the value of the objective function H including the performance function Hₚ becomes as greater as possible.

As the constraint function H_{c}, it is possible to use a function to increase its function value to be greater when the candidate solution {αᵢ} satisfies the constraint condition than when the candidate solution {αᵢ} does not satisfy the constraint condition, wherein the constrained weight can be set to a value equal to or greater than zero. Alternatively, as the constraint function H_{c}, it is possible to use a function to decrease its function value when the candidate solution {αᵢ} satisfies the constraint condition compared with when the candidate solution {αᵢ} does not satisfy the constraint condition, wherein the constrained weight can be set to a value equal to or smaller than zero.

In addition, the coefficient for adjusting the degree of impact between the performance-indicator value and the constraint-indicator value can be applied to the constraint indicator instead of or in addition to the performance indicator.

The coefficient setting unit 110 is configured to set the constrained weight C. Setting the constrained weight C may include updating the constrained weight C, e.g., re-setting the constrained weight C to overwrite its already-set value.

As the constrained weight C becomes smaller, an impact of the constraint function H_{c} to the objective function H becomes smaller than an impact of the performance function Hₚ to the objective function H. In this point, it is expected to easily produce candidate solutions having a relatively small value of the performance function Hₚ, but a likelihood that candidate solutions may satisfy the constraint condition may become relatively low.

As the constrained weight C becomes greater, an impact of the constraint function H_{c} to the objective function H becomes greater than an impact of the performance function Hₚ to the objective function H. In this point, it is expected to increase a likelihood that candidate solutions may satisfy the constraint condition, but it becomes difficult to produce candidate solutions having a relatively small value of the performance function Hₚ.

As described above, it is observed that the constrained weight C may have a great impact on values of solutions produced by the computation apparatus 100. For this reason, the coefficient setting unit 110 is configured to update the constrained weight C according to candidate solutions when the computation apparatus 100 solves the optimization problem having a constraint condition. In particular, the coefficient setting unit 110 may set the constrained weight C according to the value of the objective function H for candidate solutions satisfying the constraint condition and the value of the objective function H for candidate solutions unsatisfying the constraint condition.

The solution acquisition unit 120 is configured to acquire a solution to a conditioned optimization problem to be solved by the computation apparatus 100 using the objective function H. In particular, the solution acquisition unit 120 is configured to acquire a candidate solution using the objective function H for which the coefficient setting unit 110 sets the constrained weight C. Subsequently, the solution acquisition unit 120 detects a candidate solution having the smallest value of the objective function H among candidate solutions satisfying the constraint condition, thus outputting the detected candidate solution as a solution to the conditioned optimization problem to be solved by the computation apparatus 100.

The input/output unit 130 is configured to input or output data. For example, the input/output unit 130 outputs a solution acquired by the solution acquisition unit 120. The input/output unit 130 may have a communication function to communicate with other devices. For example, the input/output unit 130 may transmit to an external device a solution acquired by the solution acquisition unit 120.

The input/output unit 130 may have another function serving as a user interface instead of or in addition to the communication function to communicate with other devices. For example, the input/output unit 130 may include an input device such as a keyboard and a mouse, thus accepting a user operation such as an instruction to execute a process of calculating solutions. In addition, the input/output unit 130 may include a display device such as a liquid-crystal display and an LED (Light-Emitting Diode) panel, thus displaying various images such as solutions acquired by the solution acquisition unit 120.

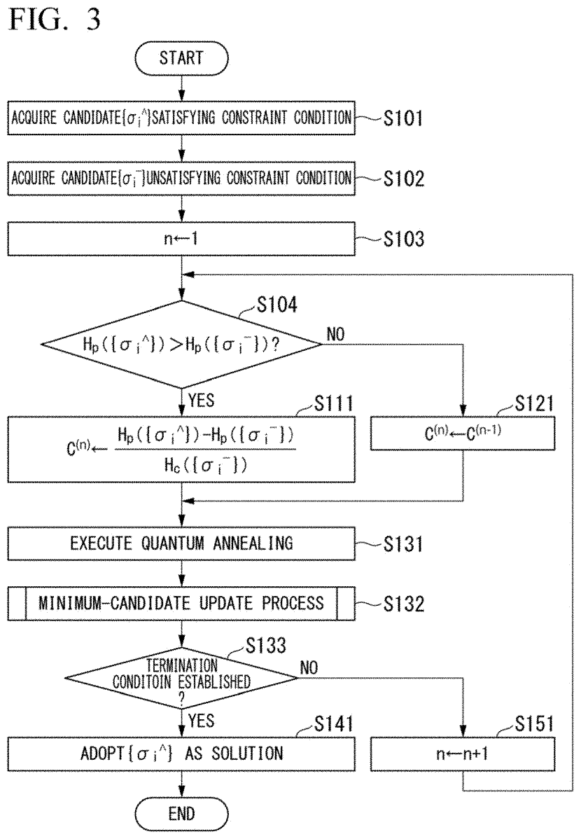

FIG. 3 is a flowchart showing a procedure example for calculating solutions with the computation apparatus 100. According to the procedure of FIG. 3, the solution acquisition unit 120 acquires one candidate solution satisfying the constraint condition, thus setting it as an initial value of a candidate solution {σ^{\hat{ }}ᵢ} satisfying the constraint condition (step S101). The candidate solution {σ^{\hat{ }}ᵢ} satisfying the constraint condition is selected from among candidate solutions satisfying the constraint condition so as to calculate the value of the constrained weight C. As the candidate solution {σ^{\hat{ }}ᵢ} satisfying the constraint condition, the solution acquisition unit 120 uses a candidate solution having the minimum value of the performance function Hₚ among candidate solutions satisfying the constraint condition. Herein, the candidate solution {σ^{\hat{ }}ᵢ} satisfying the constraint condition will be referred to as a candidate {σ^{\hat{ }}ᵢ} satisfying the constraint condition or minimizing the performance-function value or simply a candidate solution {σ^{\hat{ }}ᵢ}.

In step S101, a method for the solution acquisition unit 120 to acquire one candidate solution satisfying the constraint condition is not necessarily limited to a specific method. For example, the solution acquisition unit 120 may acquire from the input/output unit 130 a candidate solution satisfying the constraint condition acquired by a user. Alternatively, a user may acquire a candidate solution satisfying the constraint condition via any measure, wherein the user may perform a user operation to input the candidate solution into the computation apparatus 100 using the input/output unit 130. Subsequently, the solution acquisition unit 120 may acquire the candidate solution indicated by the user operation accepted by the input/output unit 130.

A prescribed method for producing candidate solutions satisfying constraint conditions may be determined depending on the type of the conditioned optimization problem. As to the traveling salesman problem, for example, it is possible to produce a candidate solution satisfying a constraint condition by connecting all cities in a unicursal manner. As to the conditioned optimization problem having an already-known method for producing candidate solutions satisfying constraint conditions, the solution acquisition unit 120 may produce candidate solutions satisfying constraint conditions using the already-known method.

Alternatively, the computation apparatus 100 may repeatedly perform an operation of producing any candidate solution by randomly setting the constrained weight C until it successfully obtains a candidate solution satisfying a constraint condition. Subsequently, the solution acquisition unit 120 may set the obtained candidate solution satisfying the constraint condition as an initial value of a candidate {σ^{\hat{ }}ᵢ} satisfying the constraint condition and minimizing the performance-function value.

After step S101, the solution acquisition unit 120 acquires one candidate solution unsatisfying the constraint condition, thus setting it as an initial value of a candidate solution {σ⁻ᵢ} unsatisfying the constraint condition (step S102). The candidate solution {σ⁻ᵢ} unsatisfying the constraint condition is selected from among candidate solutions unsatisfying the constraint condition so as to calculate the value of the constrained weight C. As the candidate solution {σ⁻ᵢ} unsatisfying the constraint condition, the solution acquisition unit 120 uses a candidate solution having the minimum value of the performance function Hₚ among candidate solutions unsatisfying the constraint condition. Herein, the candidate solution {σ⁻ᵢ} unsatisfying the constraint condition will be referred to as a solution {σ⁻ᵢ} unsatisfying the constraint condition and minimizing the performance-function value or simply a candidate solution {σ⁻ᵢ}.

In step S102, a method for the solution acquisition unit 120 to acquire one candidate solution unsatisfying the constraint condition is not necessarily limited to a specific method. For example, the solution acquisition unit 120 may acquire a candidate solution unsatisfying the constraint condition acquired by a user via the input/output unit 130. Alternatively, a user may acquire a candidate solution unsatisfying the constraint condition via any measure so as to perform a user operation to input the obtained candidate solution into the computation apparatus 100 using the input/output unit 130. Subsequently, the solution acquisition unit 120 may acquire the candidate solution indicated by the user operation accepted by the input/output unit 130.

Alternatively, the computation apparatus 100 may repeatedly perform an operation of producing any candidate solution to reduce the value of the objective function H as much as possible until it successfully obtains a candidate solution unsatisfying the constraint condition. Subsequently, the solution acquisition unit 120 may set the obtained candidate solution unsatisfying the constraint condition to an initial value of the candidate solution {σ⁻ᵢ}. In this connection, it is expected to obtain a candidate solution unsatisfying the constraint condition more easily than a candidate solution satisfying the constraint condition.

After step S102, the coefficient setting unit 110 sets a variable n to “1” (step S103). In FIG. 3, the variable n is a loop-counter variable for counting the number of times for repeating a loop ranging from step S104 to step S133.

Next, the coefficient setting unit 110 determines whether or not to establish an inequality of Hₚ({σ\hat{ }ᵢ})>Hₚ({σ⁻ᵢ}) (step S104). That is, the coefficient setting unit 110 determines whether or not the value Hₚ({σ^{\hat{ }}ᵢ}) of the performance function Hₚ related to the candidate solution {σ\hat{ }ᵢ} satisfying the constraint condition and minimizing the performance-function value is greater than the value Hₚ({σ⁻ᵢ}) of the performance function Hₚ related to the candidate solution {σ⁻ᵢ} unsatisfying the constraint condition but minimizing the performance-function value.

Upon determining Hₚ({σ\hat{ }ᵢ})>Hₚ({σ⁻ᵢ}) (step S104: YES), the coefficient setting unit 110 sets the constrained weight C⁽ⁿ⁾ to a value calculated by dividing a difference of Hₚ({σ^{\hat{ }}ᵢ})−Hₚ({σ⁻ᵢ}) by H_{c}({σ⁻ᵢ}) (step S111). Herein, H_{c}({σ⁻ᵢ}) indicates a constraint-function value for the candidate solution {σ⁻ᵢ} unsatisfying the constraint condition but minimizing the performance-function value.

In the above, the constrained weight C⁽ⁿ⁾ represents a constrained weight C which is set by the coefficient setting unit 110 by executing a loop of steps S104-S133 n times. The coefficient setting unit 110 may set a value of the constrained weight C⁽ⁿ⁾ in either step S111 or step S121 every time it repeats a loop of steps S104-S133.

Formula (6) indicates a process for setting a value of the constrained weight C⁽ⁿ⁾ by the coefficient setting unit 110 in step S111.

$${C}^{( n )} ← \frac{{H}_{p} ( \{ {σ}_{i}^{\hat{}} \} ) - {H}_{p} ( \{ {σ}_{i}^{-} \} )}{{H}_{c} ( \{ {σ}_{i}^{-} \} )} \qquad ( 6 )$$

The numerator of the right side of Formula (6) “Hₚ({σ\hat{ }ᵢ})−Hₚ({σ⁻ᵢ})” represents a difference produced by subtracting the value of the performance function Hₚ related to the candidate solution unsatisfying the constraint condition from the value of the performance function Hₚ related to the candidate solution satisfying the constraint condition. When the above difference is large, it is highly likely that the candidate solution minimizing the value of the objective function H as much as possible may not satisfy the constraint condition.

For this reason, the coefficient setting unit 110 needs to increase the value of the constrained weight C⁽ⁿ⁾ to be larger as the difference becomes larger. An impact of the value of the constraint condition on the value of the objective function H becomes larger as the value of the constrained weight C⁽ⁿ⁾ becomes larger, and therefore it is expected that the candidate solution satisfying the constraint condition can be produced with ease.

In this connection, it is possible to prevent the coefficient setting unit 110 from setting a negative value as the constrained coefficient C⁽ⁿ⁾ in step S111 by way of a conditional branch at step S104 before step S111.

Next, the solution acquisition unit 120 executes quantum annealing using the constrained weight C of the objective function H as the constrained weight C⁽ⁿ⁾ set by the coefficient setting unit 110, thus acquiring a candidate solution (step S131). Executing step S131 once may cause the solution acquisition unit 120 to perform quantum annealing multiple times, thus acquiring multiple candidate solutions. For example, executing step S131 once may cause the solution acquisition unit 120 to perform quantum annealing one-thousand times, thus acquiring one-thousand candidate solutions.

Subsequently, the solution acquisition unit 120 performs a process for updating the candidate solution {σ\hat{ }ᵢ} satisfying the constraint condition and minimizing the performance-function value and the candidate solution {σ⁻ᵢ} unsatisfying the constraint condition but minimizing the performance-function solution (step S132). This process will be referred to as a minimum-candidate-updating process.

Next, the solution acquisition unit 120 determines whether or not to establish a termination condition for a loop of steps S104-S133 (step S133). The termination condition is limited to a specific condition. For example, the termination condition of step S133 may be a condition that the number of times for repeating a loop of steps S104-S133 reaches a predetermined threshold value. Alternatively, the termination condition of step S133 may be a condition that the number of times for repeating a loop of steps S104-S133 is equal to or above a predetermined number of times or a condition that the value H({σ^{\hat{ }}ᵢ}) of the objective function related to the candidate solution {σ^{\hat{ }}ᵢ} satisfying the constraint condition and minimizing the performance-function value is not decreased.

In this connection, the value of the constrained weight C may not affect the value H({σ^{\hat{ }}ᵢ}) of the objective function H since the value of the constrained function H_{c} will become zero with respect to the candidate solution {σ^{\hat{ }}ᵢ} satisfying the constraint condition and minimizing the performance-function value. For this reason, the value of the objective function related to the candidate solution {σ^{\hat{ }}ᵢ} satisfying the constraint condition and minimizing the performance-function value will be expressed as “H({σ^{\hat{ }}ᵢ})” without explicitly indicating the constrained weight C.

When the solution acquisition unit 120 determines that the termination condition is not established in step S133 (step S133: NO), the coefficient setting unit 110 may increase the variable n by one (step S151). After step S151, the flow returns to step S104.

On the other hand, upon determining that the termination condition is established in step S133 (step S133: YES), the solution acquisition unit 120 employs the candidate solution {σ^{\hat{ }}ᵢ} satisfying the constraint condition and minimizing the performance-function value as an actual solution to the optimization problem having the constraint condition to be solved by the computation apparatus 100 (step S141). After step S141, the computation apparatus 100 exits the procedure of FIG. 3.

Upon determining Hₚ({σ\hat{ }ᵢ}≤Hₚ({σ⁻ᵢ}) in step S104 (step S104: NO), the coefficient setting unit 110 sets the value of the constrained weight C⁽ⁿ⁾ as the same value of C⁽ⁿ⁻¹⁾ (step S121). In this case, the coefficient setting unit 110 maintains the value of the constrained weight C without updating it. After step S121, the flow proceeds to step S131.

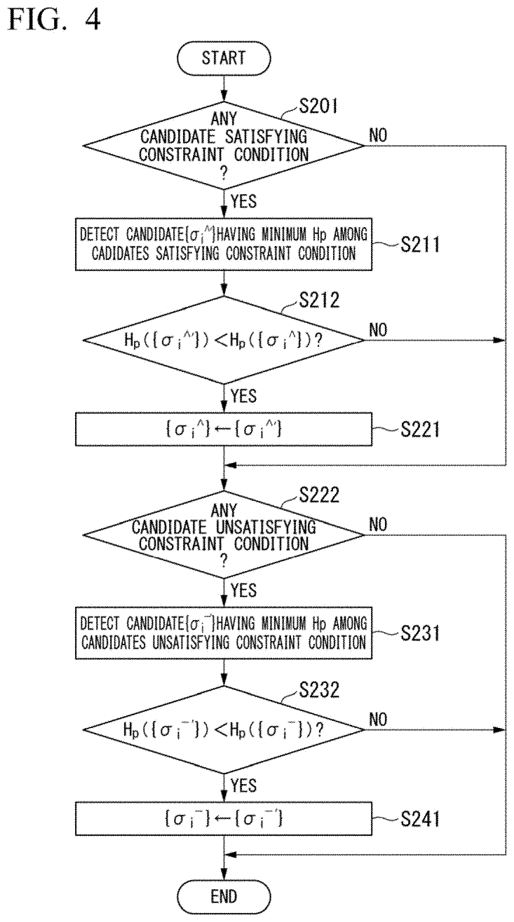

FIG. 4 is a flowchart showing a procedure example for the computation apparatus 100 to perform a minimum-candidate-updating process. The computation apparatus 100 carries out the procedure of FIG. 4 at step S132 of FIG. 3. According to the procedure of FIG. 4, the solution acquisition unit 120 determines whether any candidate solution satisfying the constraint condition be included in candidate solutions obtained at step S131 of FIG. 3 (step S201).

Upon determining the existence of any candidate solution satisfying the constraint condition (step S201: YES), the solution acquisition unit 120 detects a candidate solution minimizing the value of the performance function Hₚ among candidate solutions satisfying the constraint condition obtained at step S131 of FIG. 3 (step S211). The detected candidate solution will be denoted as {σ\hat{ }ᵢ′}.

Next, the solution acquisition unit 120 determines whether or not an inequality of Hₚ({σ\hat{ }ᵢ′})<Hₚ({σ^{\hat{ }}ᵢ}) is established (step S212). That is, the solution acquisition unit 120 determines whether or not the value Hₚ({σ\hat{ }ᵢ′}) of the performance function Hₚ related to the candidate solution WO detected at step S221 is smaller than the value Hₚ({σ^{\hat{ }}ᵢ}) of the performance function Hₚ related to the candidate solution {σ^{\hat{ }}ᵢ} satisfying the constraint condition and minimizing the performance-function value.

Upon determining Hₚ({σ\hat{ }ᵢ′})<Hₚ({σ\hat{ }ᵢ}) (step S212: YES), the solution acquisition unit 120 updates the candidate solution {σ\hat{ }ᵢ} satisfying the constraint condition and minimizing the performance-function value (step S221). Specifically, the solution acquisition unit 120 employs the candidate solution {σ\hat{ }ᵢ′} detected at step S211 as the candidate solution {σ\hat{ }ᵢ} satisfying the constraint condition and minimizing the performance-function value.

Next, the solution acquisition unit 120 determines whether or not any candidate solution unsatisfying the constraint condition is included in candidate solutions obtained at step S131 of FIG. 3 (step S122).

Upon determining the existence of any candidate solution unsatisfying the constraint condition (step S222: YES), the solution acquisition unit 120 detects any candidate solution minimizing the value of the performance function Hₚ among candidate solutions unsatisfying the constraint condition which are obtained at step S131 (step S231). The detected candidate solution will be denoted as {σ⁻ᵢ′}.

Subsequently, the solution acquisition unit 120 determines whether or not an inequality of Hₚ({σ\hat{ }ᵢ′})<Hₚ({σ⁻ᵢ}) is established (step S232). That is, the solution acquisition unit 120 determines whether or not the value Hₚ({σ⁻ᵢ′}) of the performance function Hₚ related to the candidate solution {σ⁻ᵢ′} detected at step S231 is smaller than the value Hₚ({σ⁻ᵢ}) of the performance function Hₚ related to the candidate solution unsatisfying the constraint condition but minimizing the performance-function value.

Upon determining Hₚ({σ⁻ᵢ′})<Hₚ({σ⁻ᵢ}) (step S232: YES), the solution acquisition unit 120 updates the candidate solution {σ⁻ᵢ} unsatisfying the constraint condition but minimizing the performance-function value (step S241). Specifically, the solution acquisition unit 120 employs the candidate solution {σ⁻ᵢ′} detected at step S211 as the candidate solution {σ⁻ᵢ} unsatisfying the constraint condition but minimizing the performance-function value. After step S241, the computation apparatus 100 exits the procedure of FIG. 4.

On the other hand, when the solution acquisition unit 120 determines the nonexistence of any candidate solution satisfying the constraint condition in step S201 (step S201: NO), the flow proceeds to step S222.

When the solution acquisition unit 120 determines the nonexistence of any candidate solution unsatisfying the constraint condition in step S222 (step S222: NO), the computation apparatus 100 exits the procedure of FIG. 4.

When the solution acquisition unit 120 determines an inequality of Hₚ({σ⁻ᵢ′})<Hₚ({σ⁻ᵢ}) in step S232 (step S232: NO), the computation apparatus 100 exits the procedure of FIG. 4.

The operation of the coefficient setting unit 110 configured to set the value of the constrained weight C will be further described below.

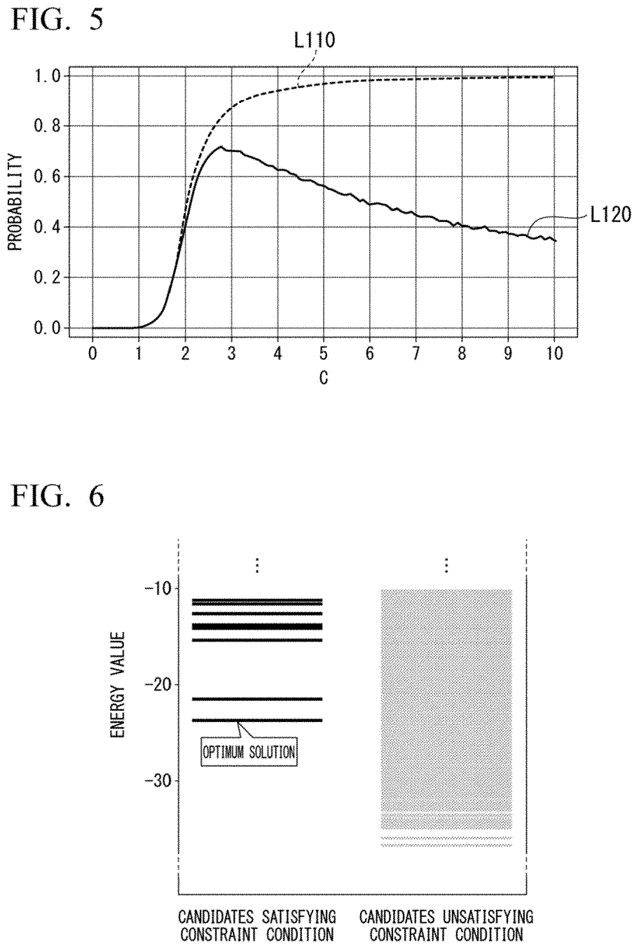

FIG. 5 is a graph showing an example of the relationship of the value of the constrained weight C, the probability of producing any candidate solution satisfying the constraint condition, and the probability of successfully producing the optimum solution. FIG. 5 shows the relationship of the value of the constrained weight, the probability of producing any candidate solution satisfying the constraint condition, and the probability of successfully producing the optimum solution when producing candidate solutions of the optimization problem, which can be obtained by randomly setting the coefficient Jₖ of Formula (4) using the LHZ model via the simulated annealing. The horizontal axis of the graph of FIG. 5 represents the value of the constrained weight C while the vertical axis represents the probability.

A line segment L110 shows the relationship between the value of the constrained weigh C and the probability of producing solutions satisfying the constraint condition. Herein, the probability of producing solutions satisfying the constraint condition is calculated as a ratio of the number of times for producing solutions satisfying the constraint condition to the number of times for producing solutions using the value of the constrained weight C shown in the horizontal axis.

A line segment L120 shows the relationship between the value of the constrained weight C and the probability of successfully producing the optimum solution. Herein, the probability of successfully producing the optimum solution is calculated as a ratio of the number of times for producing solutions as the optimum solution to the number of times for producing candidate solutions using the value of the constrained weight C shown in the horizonal axis.

In an example of FIG. 5, the value of the constrained weight C about “3” (ranging from 2.7 to 3.2) may increase a probability of successfully obtaining the optimum solution. As the problem used for the example of FIG. 5, it can be said that the optimum value of the constrained weight C would be “3”.

A smaller value of the constrained weight C than the optimum value may reduce a probability of producing any candidate solution satisfying the constraint condition, thus reducing a probability of successfully producing the optimum solution. On the other hand, a larger value of the constrained weight C than the optimum value may increase a probability of producing any candidate solution satisfying the constraint condition, thus reducing a probability of successfully producing the optimum solution due to a tendency of increasing the value of the objective function H related to each candidate solution.

With reference to FIG. 6 through FIG. 9, various examples of distribution of values to be produced by the objective function H will be described with respect to candidate solutions satisfying the constraint condition and candidate solutions unsatisfying the constraint condition by setting various values of the constrained weight C with respect to the optimization problem having the same constraint condition. As described above, the Ising variable σᵢ or the variable xᵢ is expressed as a discrete value, and therefore the object function H would produce a discrete value.

FIG. 6 is a graph showing a first example of distribution of values to be produced by the objective function H with respect to candidate solutions satisfying the constraint condition and candidate solutions unsatisfying the constraint condition when the value of the constrained weight C is set to zero in the problem applied to the example of FIG. 5.

In the graph of FIG. 6, the vertical axis represents the value of the objective function H, which will be referred to as an energy value. Among candidate solutions satisfying the constraint condition in FIG. 6, the optimum solution would be a candidate solution having the lowest energy value about −23 along the vertical axis of FIG. 6.

The example of FIG. 6 sets the value of the constrained weight C to zero, indicating that the constraint function may not affect the energy value. For this reason, it is possible to produce a candidate solution having a small value of the performance function Hₚ as a candidate solution having a low energy value irrespective of whether or not the candidate solution satisfies the constraint condition. This may yield a small ratio of candidate solutions satisfying the constraint condition to all candidate solutions to be produced, thus indicating a small probability of successfully producing the optimum solution. Even in the graph of FIG. 5, the probability of producing any candidate solution satisfying the constraint condition and the probability of successfully producing the optimum solution would be approximately zero when C=0.

For this reason, it is possible to consider that the value of the constrained weight C should be increased due to a small ratio of candidate solutions satisfying the constraint condition to all candidate solutions to be produced. This may introduce an energy value as a penalty ascribed to the constraint function H_{c} into an energy value of each candidate solution unsatisfying the constraint condition, and therefore it is expected to reduce a rate of producing candidate solutions unsatisfying the constraint condition.

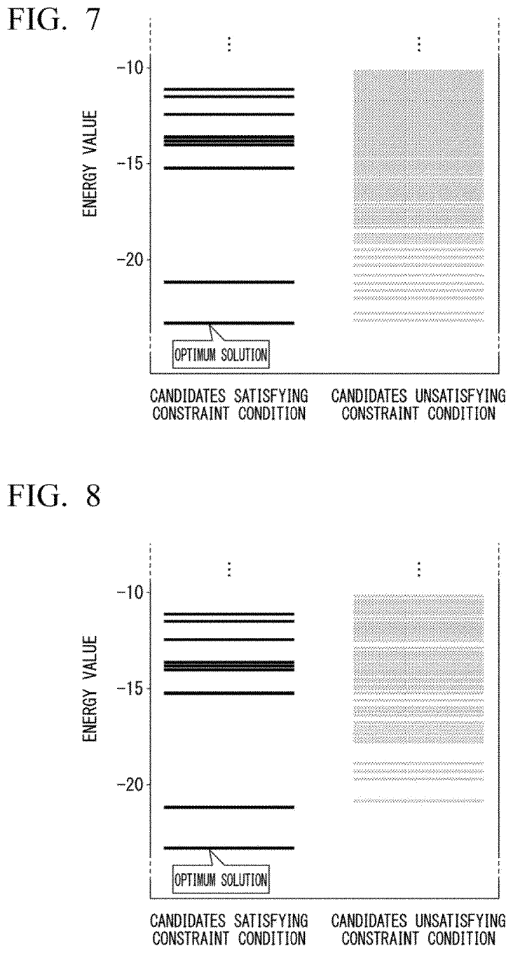

FIG. 7 is a graph showing a second example of distribution of values to be produced by the objective function H with respect to candidate solutions satisfying the constraint condition and candidate solutions unsatisfying the constraint condition when the value of the constrained weight C is set to 1.8 in the problem applied to the example of FIG. 5.

In the graph of FIG. 7, the vertical axis represents the energy value (i.e., the value of the objective function H). In the example of FIG. 7, the optimum solution would be a candidate solution having the lowest energy value (e.g., an energy value of about −23) among candidate solutions satisfying the constraint condition.

Compared with FIG. 6 where C=0, FIG. 7 where C=1.8 indicates an increasing tendency of the value of the objective function H to be produced for candidate solutions unsatisfying the constraint condition. FIG. 7 shows that the minimum value of the objective function H to be produced with respect to any candidate solution unsatisfying the constraint condition would be approximately identical to the minimum value of the objective function H to be produced with respect to any candidate solution satisfying the constraint condition.

In FIG. 7 compared to FIG. 6, it is expected to increase a probability of producing candidate solutions satisfying the constraint condition due to a large value of the objective function H to be produced with respect to any candidate solution unsatisfying the constraint condition, and therefore it is expected to increase a probability of successfully producing the optimum solution. In the graph of FIG. 5, C=1.8 compared to C=0 may increase both the probability of producing candidate solutions satisfying the constraint condition and the probability of successfully producing the optimum solution.

FIG. 8 is a graph showing a third example of distribution of values to be produced by the objective function H with respective to candidate solutions satisfying the constraint condition and candidate solutions unsatisfying the constraint condition when the value of the constrained weight C is set to 2.8 in the problem applied to the example of FIG. 5.

In the graph of FIG. 8, the vertical axis represents the energy value (i.e., the value of the objective function H). In the example of FIG. 8, the optimum solution would be a candidate solution having the lowest energy value (e.g., an energy value of about −23) among candidate solutions satisfying the constraint condition.

Compared with FIG. 7 where C=1.8, FIG. 8 where C=2.8 indicates an increasing tendency of the value of the objective function H to be produced for candidate solutions unsatisfying the constraint condition. FIG. 8 shows that the minimum value of the objective function H to be produced with respect to any candidate solution satisfying the constraint condition would be slightly smaller than the value of the objective function H to be produced with respect to any candidate solution unsatisfying the constraint condition.

In FIG. 8 compared to FIG. 7, it is expected to increase a probability of producing candidate solutions satisfying the constraint condition due to a large value of the objective function H to be produced with respect to any candidate solution unsatisfying the constraint condition, and therefore it is expected to increase a probability of successfully producing the optimum solution. In the graph of FIG. 5, C=2.8 compared to C=1.8 may increase both the probability of producing candidate solutions satisfying the constraint condition and the probability of successfully producing the optimum solution.

FIG. 9 is a graph showing a fourth example of distribution of values to be produced by the objective function H with respect to candidate solutions satisfying the constraint condition and candidate solutions unsatisfying the constraint condition when the value of the constrained weight C is set to 36.7 in the problem applied to the example of FIG. 5.

In the graph of FIG. 9, the vertical axis represents the energy value (i.e., the value of the objective function H). In the example of FIG. 9, the optimum solution would be a candidate solution having the lowest energy value (e.g., an energy value of about −23) among candidate solutions satisfying the constraint condition.

In the example of FIG. 9, the energy value for each candidate solution satisfying the constraint condition is smaller than the minimum energy value among candidate solutions unsatisfying the constraint condition. By increasing the constrained weight C, it is expected to easily produce a candidate solution satisfying the constraint condition. However, a large value of the constrained weight C may enhance the value of the constraint function H_{c} in the value of the objective function H while relatively reducing an impact of the value on the performance function Hₚ. This is because a relatively small difference of magnitude appears between the optimum solution and other candidate solutions satisfying the constraint condition in terms of the value of the objective function H upon comparing the value of the objective function H for each candidate solution satisfying the constraint condition and the value of the objective function H for each candidate solution unsatisfying the constraint condition, making it easy for the solution acquisition unit 120 to acquire other candidate solutions satisfying the constraint condition than the optimum solution.

In the example of FIG. 9 compared with the example of FIG. 8, it is possible to consider that a probability of successfully producing the optimum solution would be small. This assumption may conform to the assessment of the graph of FIG. 5 in which increasing the optimum value of the constrained weight C (about 3) would further increase the probability of producing candidate solutions satisfying the constraint condition but further decreasing the probability of successfully producing the optimum solution.

When the minimum energy value for candidate solutions satisfying the constraint condition is excessively larger or smaller than the minimum energy value for candidate solutions unsatisfying the constraint condition, it is possible to consider that a probability of successfully producing the optimum solution would be small. For this reason, it is possible to contemplate setting the value of the constrained weight C such that the minimum energy value for candidate solutions satisfying the constraint condition be close (or approximate) to the minimum energy value for candidate solutions unsatisfying the constraint condition.

A strict analysis would be needed to detect values to be produced by the performance function H. Normally, it is uncertain which value can be produced by the performance function when solving the optimization problem having its constraint condition.

For this reason, the coefficient setting unit 110 is configured to detect a candidate solution minimizing the value of the objective function H with respect to a set of candidate solutions satisfying the constraint condition and a set of candidate solutions unsatisfying the constraint condition among all candidate solutions produced as described above. Subsequently, the coefficient setting unit 110 will set a suitable value of the constrained weight C such that the minimum value of the objective function H for candidate solutions satisfying the constraint condition may approach the minimum value of the objective function H for candidate solutions unsatisfying the constraint condition. Upon obtaining a new candidate solution, the coefficient setting unit 110 detects any candidate solution minimizing the value of the objective function H again so as to re-set the value of the constrained weight C.

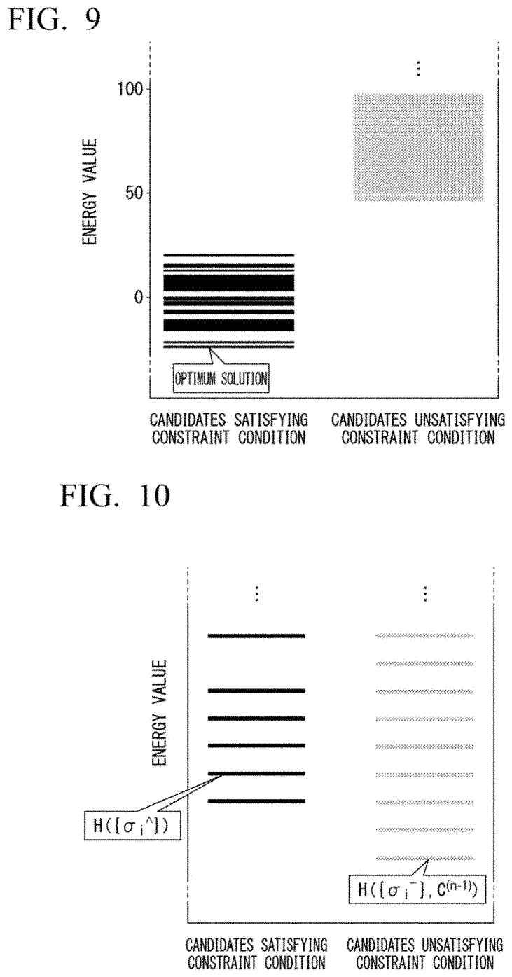

FIG. 10 is a graph showing a first example of distribution of values to be produced by the objective function H before updating the value of the constrained weight C with the coefficient setting unit 110. FIG. 10 shows an example of distributions of values to be produced by the performance function H with respect to candidate solutions satisfying the constraint condition and candidate solutions unsatisfying the constraint condition when the value H({σ⁻ᵢ},C⁽ⁿ⁻¹⁾) of the objective function H related to the candidate solution {σ⁻ᵢ} unsatisfying the constraint condition but minimizing the performance-function value is smaller than the value H({σ^{\hat{ }}ᵢ}) of the objective function H related to the candidate solution {σ\hat{ }ᵢ} satisfying the constraint condition and minimizing the performance-function value.

In the graph of FIG. 10, the vertical axis represents the energy value (i.e., the value of the objective function H).

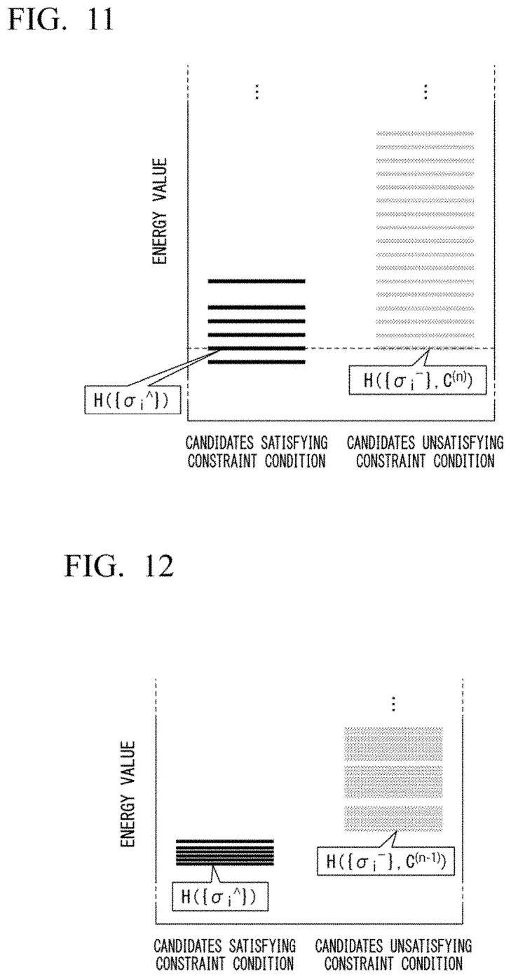

FIG. 11 is a graph showing a first example of distribution of values to be produced by the objective function H after updating the value of the constrained weight C with the coefficient setting unit 110. In the example of FIG. 11 derived from the example of FIG. 10, the coefficient setting unit 110 updates the value of the constrained weight C such that the value H({σ⁻ᵢ},C⁽ⁿ⁾) of the objective function H related to the candidate solution {σ⁻ᵢ} unsatisfying the constraint condition but minimizing the performance-function value becomes identical to the value H({σ^{\hat{ }}ᵢ}) of the objective function H related to the candidate solution {σ^{\hat{ }}ᵢ} satisfying the constraint condition and minimizing the performance-function value.

As shown in the example of FIG. 11, Formula (7) expresses that the value H({σ⁻ᵢ},C⁽ⁿ⁾) of the objective function H becomes identical to the value H({σ\hat{ }ᵢ}) of the objective function H related to the candidate solution {σ^{\hat{ }}ᵢ} satisfying the constraint condition and minimizing the performance-function value.

H({σᵢ⁻},C⁽ⁿ⁾)=H({σᵢ^{\hat{ }}}) (7)

It is possible to transform Formula (7) into Formula (8) using Formula (1).

Hₚ({σᵢ⁻})C⁽ⁿ⁾H_{c}({σᵢ⁻})=Hₚ({σᵢ^{\hat{ }}}) (8)

It is possible to derive Formula (9) from Formula (8).

$${C}^{( n )} = \frac{{H}_{p} ( \{ {σ}_{i}^{\hat{}} \} ) - {H}_{p} ( \{ {σ}_{i}^{-} \} )}{{H}_{c} ( \{ {σ}_{i}^{-} \} )} \qquad ( 9 )$$

The right side of Formula (9) is similar to the right side of Formula (6). Therefore, when the coefficient setting unit 110 sets (or updates) the value of the constrained weight C according to Formula (6), as shown in the example of FIG. 11, it is possible to equalize the value H({σ⁻ᵢ},C⁽ⁿ⁾) of the objective function H related to the candidate solution {σ⁻ᵢ} unsatisfying the constraint condition but minimizing the performance-function value with the value H({σ^{\hat{ }}ᵢ}) of the objective function H related to the candidate solution {σ\hat{ }ᵢ} satisfying the constraint condition and minimizing the performance-function value. This is expressed by Formula (10).

H({ᵢ⁻},C⁽ⁿ⁻¹⁾)<H({σᵢ^{\hat{ }}}) (10)

Similar to the transformation from Formula (7) to Formula (9), it is possible to transform Formula (10) into Formula (11).

$${C}^{( n - 1 )} < \frac{{H}_{p} ( \{ {σ}_{i}^{\hat{}} \} ) - {H}_{p} ( \{ {σ}_{i}^{-} \} )}{{H}_{c} ( \{ {σ}_{i}^{-} \} )} \qquad ( 11 )$$

Due to the similarity between the right side of Formula (9) and the right side of Formula (11), it is possible to express the relationship between C⁽ⁿ⁾ and C⁽ⁿ⁻¹⁾ by Formula (12).

c⁽ⁿ⁾>c⁽ⁿ⁻¹⁾ (12)

As described above, the value of the constrained weight C should be increased when the value H({σ⁻ᵢ},C⁽ⁿ⁻¹⁾) of the objective function H related to the candidate solution {σ⁻ᵢ} unsatisfying the constraint condition but minimizing the performance-function value is smaller than the value H({σ^{\hat{ }}ᵢ}) of the objective function H related to the candidate solution {σ^{\hat{ }}ᵢ} satisfying the constraint condition and minimizing the performance-function value. Thus, it is possible to approach the value H({σ⁻ᵢ},C⁽ⁿ⁻¹⁾) of the objective function H related to the candidate solution {σ⁻ᵢ} unsatisfying the constraint condition but minimizing the performance-function value to the value H({σ^{\hat{ }}ᵢ}) of the objective function H related to the candidate solution {σ^{\hat{ }}ᵢ} satisfying the constraint condition and minimizing the performance-function value.

FIG. 12 is a graph showing a second example of distribution of values to be produced by the objective function H before updating the value of the constrained weight C with the coefficient setting unit 110. FIG. 12 shows an example of distribution of values to be produced by the objective function H with respect to candidate solutions satisfying the constraint condition and candidate solutions unsatisfying the constraint condition when the value H({σ⁻ᵢ},C⁽ⁿ⁻¹⁾) of the objective function H related to the candidate solution {σ⁻ᵢ} unsatisfying the constraint condition but minimizing the performance-function value is larger than the value H({σ^{\hat{ }}ᵢ}) of the objective function H related to the candidate solution {σ^{\hat{ }}ᵢ} satisfying the constraint condition and minimizing the performance-function value. In the graph of FIG. 12, the vertical axis represents the energy value (or the value of the objective function H).

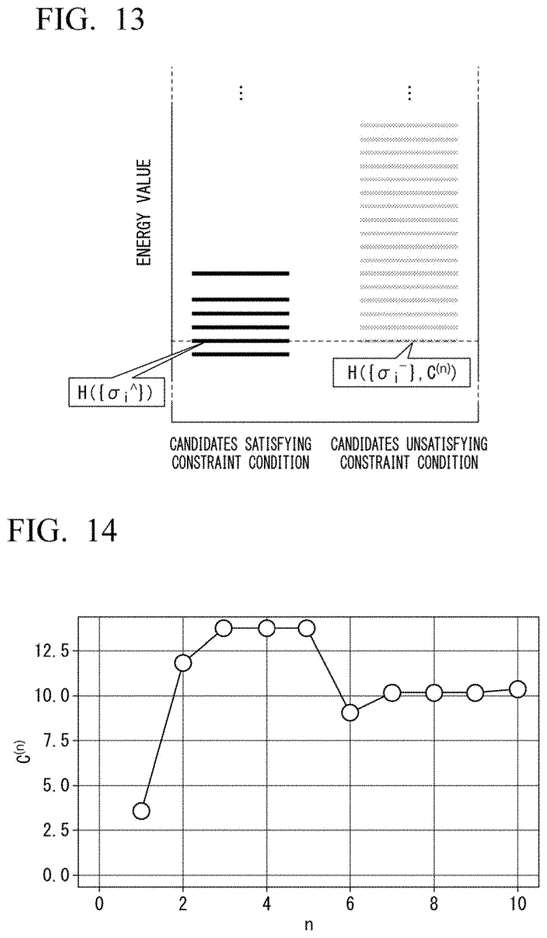

FIG. 13 is a graph showing a second example of distribution of values to be produced by the objective function H after updating the value of the constrained weight C with the coefficient setting unit 110. The example of FIG. 13 derived from the example of FIG. 12 is created by updating the value of the constrained weight C such that when the value H({σ⁻ᵢ},C⁽ⁿ⁻¹⁾) of the objective function H related to the candidate solution {σ⁻ᵢ} unsatisfying the constraint condition but minimizing the performance-function value becomes identical to the value H({σ^{\hat{ }}ᵢ}) of the objective function H related to the candidate solution {σ^{\hat{ }}ᵢ} satisfying the constraint condition and minimizing the performance-function value.

In the example of FIG. 13, similar to the example of FIG. 11, it is possible to establish Formula (9) derived from Formula (7) indicating that the value H({σ⁻ᵢ},C⁽ⁿ⁾) of the objective function H related to the candidate solution {σ⁻ᵢ} unsatisfying the constraint condition but minimizing the performance-function value is identical to the value H({σ^{\hat{ }}ᵢ}) of the objective function H related to the candidate solution {σ^{\hat{ }}ᵢ} satisfying the constraint condition and minimizing the performance-function value. Therefore, when the coefficient setting unit 110 sets (or updates) the value of the constrained weight C according to Formula (6), it is possible to realize the example of FIG. 13 in which the value H({σ⁻ᵢ},C⁽ⁿ⁾) of the objective function H related to the candidate solution unsatisfying the constraint condition but minimizing the performance-function value is identical to the value H({σ^{\hat{ }}ᵢ}) of the objective function H related to the candidate solution {σ\hat{ }ᵢ} satisfying the constraint condition and minimizing the performance-function value.

In the condition before updating the value of the constrained weight C as shown in FIG. 12, the value H({σ⁻ᵢ},C⁽ⁿ⁻¹⁾) of the objective function H related to the candidate solution {σ⁻ᵢ} unsatisfying the constraint condition but minimizing the performance-function value is larger than the value H({σ^{\hat{ }}ᵢ}) of the objective function H related to the candidate solution {σ^{\hat{ }}ᵢ} satisfying the constraint condition and minimizing the performance-function value. This is expressed by Formula (13).

H({σᵢ⁻},C⁽ⁿ⁻¹⁾)>H({σᵢ^{\hat{ }}}) (13)

Similar to the transformation from Formula (7) to Formula (9), it is possible to transform Formula (13) into Formula (14).

$${C}^{( n - 1 )} > \frac{{H}_{p} ( \{ {σ}_{i}^{\hat{}} \} ) - {H}_{p} ( \{ {σ}_{i}^{-} \} )}{{H}_{c} ( \{ {σ}_{i}^{-} \} )} \qquad ( 14 )$$

Since the right side of Formula (9) is identical to the right side of Formula (14), it is possible to express the relationship between C⁽ⁿ⁾ and C⁽ⁿ⁻¹⁾ as Formula (15).

c⁽ⁿ⁾<c⁽ⁿ⁻¹⁾ (15)

As described above, the coefficient setting unit 110 may reduce the value of the constrained coefficient C when the value H({σ⁻ᵢ},C⁽ⁿ⁻¹⁾) of the objective function H related to the candidate solution {σ⁻ᵢ} unsatisfying the constraint condition but minimizing the performance-function value is larger than the value H({σ^{\hat{ }}ᵢ}) of the objective function H related to the candidate solution {σ^{\hat{ }}ᵢ} satisfying the constraint condition and minimizing the performance-function value. This may allow the value H({σ⁻ᵢ},C⁽ⁿ⁻¹⁾) of the objective function H related to the candidate solution {σ⁻ᵢ} unsatisfying the constraint condition but minimizing the performance-function value to approach the value H({σ^{\hat{ }}ᵢ}) of the objective function H related to the candidate solution {σ^{\hat{ }}ᵢ} satisfying the constraint condition and minimizing the performance-function value.

FIG. 14 is a graph showing an example of the relationship between the number of times for updating the value of the constrained coefficient C and the value of the constrained coefficient. FIG. 14 shows an example of the relationship between the number of times for updating the value of the constrained weight C and the value of the constrained weight C when a solution search is performed according to the process of FIG. 3 using the LHZ model for setting the optimization problem by randomly setting the value of the coefficient Jₖ in Formula (4). In the graph of FIG. 14, the vertical axis represents the number of times for updating the value of the constrained weight C while the horizontal axis represents the value of the constrained weight C. In this connection, it is already known that the value of the constrained weight C ranging from 7 to 12 may provide a relatively easy way for successfully producing the optimum solution to the optimization problem set in FIG. 14.

The example of FIG. 14 uses candidate solutions detected by persons with respect to candidate solutions {{σ^{\hat{ }}ᵢ}} satisfying the constraint condition and minimizing the performance-function value in step S101 of FIG. 3 and candidate solutions {σ⁻ᵢ} unsatisfying the constraint condition but minimizing the performance-function value in step S102. Herein, the value of the constrained weight C (about 3.5) when n=1 represents the value of the constrained weight C which can be obtained in step S111 using candidate solutions detected by persons.

In the example of FIG. 14, the value of the constrained weight C falls within a range between 7 and 12 at time of n=6 and onwards, while the value of the constrained weight C may be close to the range between 7 and 12 at each of times where n ranges from 2 to 5. In this point, it is possible to assess that the process of FIG. 3 may produce an appropriate value of the constrained weight C.

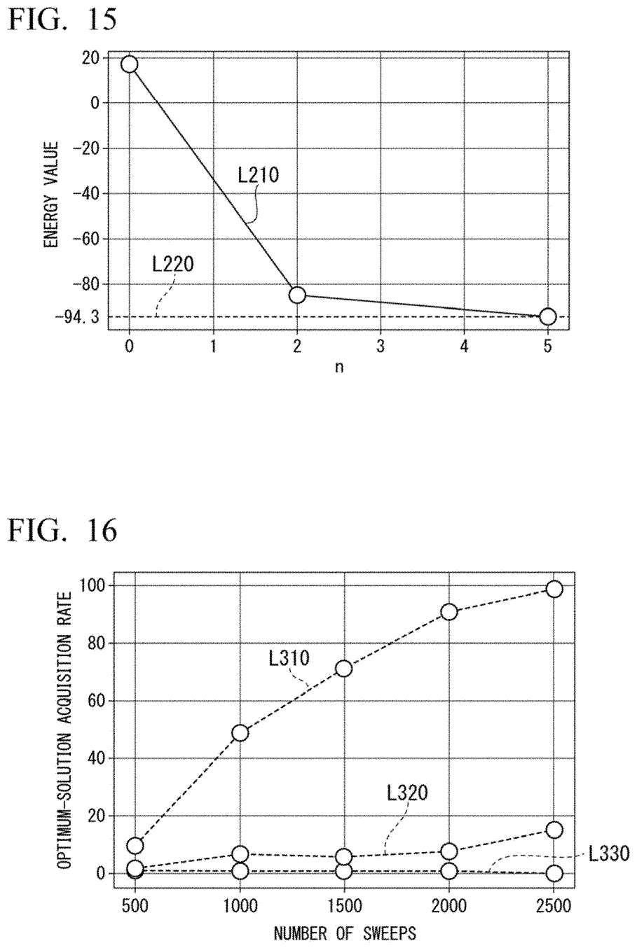

FIG. 15 is a graph showing an example of the relationship between the number of times for updating the value of the constrained weight C and the minimum value of the objective function to be produced using candidate solutions satisfying the constraint condition. FIG. 15 shows the relationship between the number of times for updating the value of the constrained weight C and the minimum value of the objective function according to a solution search in the example of FIG. 14. In the graph of FIG. 15, the horizontal axis represents the number of times for updating the value of the constrained weight C while the vertical axis represents the minimum value of the objective function related to candidate solutions.

A line segment L210 shows the relationship between the number of times for updating the value of the constrained weight C and the minimum value of the objective function. A line segment L220 shows the optimum solution to the optimization problem (i.e., the minimum value to be produced by the objective function under the constraint condition). It is already known that the optimum solution to the optimization problem is about −94.3.

The minimum value (about 18) of the objective function when n=0 indicates a value of the objective function related to a candidate solution detected by a person and satisfying the constraint condition. The example of FIG. 15 may produce the optimum solution to be produced by updating the value of the constrained weight C five times or an approximate value of the optimum solution. In this point, it is possible to determine that the process of FIG. 3 may produce an appropriate solution.

FIG. 16 is a graph showing comparative examples of optimum-solution-acquisition rates. FIG. 16 shows various rates for producing optimum solutions via experiments for solving the optimization problem, which is created by randomly setting the value of the coefficient Jₖ in Formula (4) using the LHZ model, according to the method shown in FIG. 3, any method similar to the multiple coefficients trial method, and a method for presetting the value of a constrained weight.

In the graph of FIG. 16, the horizontal axis represents the number of sweeps in quantum annealing while the horizontal axis represents a ratio of the number of times for producing optimum solutions to the number of times for executing annealing.

The multiple coefficients trial method is suggested as one solution to the traveling salesman problem. The multiple coefficients trial method employs the value of a constrained weight ascribed to the best result of the annealing which is performed by setting multiple values as the constrained weight within a range from the minimum value to the maximum value with respect to the pathway length between two cities in the traveling salesman problem. Herein, a similar method to the multiple coefficients trial method would be defined in such a way that a person may set in advance the maximum value and the minimum value with respect to the constrained weight according to the optimization problem so as to set multiple values as the constrained weight within a range between the maximum value and the minimum value, and annealing is performed using multiple values as the constrained weight, thus employing the constrained weight ascribed to the best result of annealing.

In experiments, simulated annealing is performed one-hundred times independently with respect to the number of sweeps at 500, 1,000, 1,500, 2,000, and 2,500, thus calculating the optimum-solution-acquisition rate representing the number of optimum solutions within one-hundred results for each annealing. In other words, the optimum-solution-acquisition rate represents the number of times for producing optimum solutions in a trial of performing simulated annealing one-hundred times. In the above, the number of sweeps is the number of steps (or the number of times for updating temperature) when temperature is gradually reduced from high temperature (or initial temperature) to low temperature (or final temperature) in simulated annealing.

A line segment L310 indicates the optimum-solution-acquisition rate to be produced using the method shown in FIG. 3. A line segment L320 indicates the optimum-solution-acquisition rate to be produced using a similar method to the multiple coefficients trial method when the minimum value of the constrained weight is set to zero while the maximum value is expressed as Σₖ|Jₖ|. A line segment L330 indicates the optimum-solution-acquisition rate to be produced when setting the value of the constrained weight to Σₖ|Jₖ| in advance.

FIG. 16 demonstrates that in any number of sweeps, the method shown in FIG. 3 (see the line segment L310) can produce more preferable results than a similar method to the multiple coefficients trial method (see the line segment L320) and the method for setting the constrained weight in advance (see the line segment L330). In particular, the number of sweeps at 2,500 shows the optimum-solution-acquisition rate of about 100% according to the method of FIG. 3 rather than the optimum-solution-acquisition rate of about 16% according to a similar method to the multiple coefficients trial method and the optimum-solution-acquisition rate of almost 0% according to the method for setting the constrained weight in advance. As described above, it is possible to produce a preferable result using the method of FIG. 3.

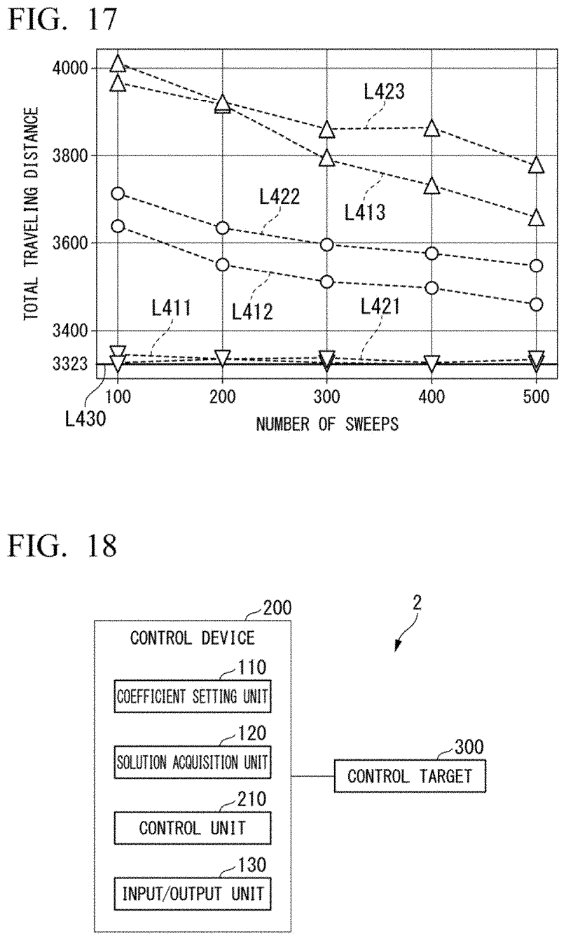

FIG. 17 is a graph showing comparative examples of total traveling distances related to solutions of the traveling salesman problem. FIG. 17 shows total traveling distances related to solutions ascribed to experiments of solving the traveling salesman problem using the number of cities, e.g., fourteen cities presented as the benchmark, using the method of FIG. 3 and the multiple coefficients trial method. In the graph of FIG. 17, the horizonal axis represents the number of sweeps in annealing while the vertical axis represents the total traveling distance.

In experiments, simulated annealing is performed one-hundred times independently with respect to the number of sweeps at 500, 1,000, 1,500, 2,000, and 2,500, thus calculating the minimum value, the average value, and the maximum value of the total traveling distance in one-hundred results. Line segments L411, L412, L413 show the minimum value, the average value, and the maximum value of the traveling distance ascribed to solutions produced using the method of FIG. 3. Line segments L421, L422, L423 show the minimum value, the average value, and the maximum value of the traveling distance ascribed to solutions produced using the multiple coefficients trial method. A line segment L430 shows the optimum solution (i.e., the minimum value of the total traveling distance). Experiments show that the total traveling distance produced by solving the traveling salesman problem has the minimum value of 3,323.

FIG. 17 shows that irrespective of the number of sweeps, the method of FIG. 3 (se the line segment L411) and the multiple coefficients trial method (see the line segment L421) produces their minimum values of the total traveling distance close to optimum solutions. As to the average value of the total traveling distance, irrespective of the number of sweeps, the method of FIG. 3 (see the line segment L412) produce a smaller value than the multiple coefficients trial method (see the line segment L422).

As to the maximum value of the total traveling distance using the number of sweeps at 2,000, the method of FIG. 3 (see the line segment L413) and the multiple coefficients trial method (see the line segment L423) produce their values approximately equal to each other. Using the number of sweeps other than 2,000, the method of FIG. 3 (see the line segment L413) produces a smaller value than the multiple coefficients trial method (see the line segment L423).

As to the traveling salesman problem for which the multiple coefficients trial method would be suitable, the method of FIG. 3 may produce a similar result to the multiple coefficients trial method or a more preferable result than the multiple coefficients trial method.

The method for the coefficient setting unit 110 to calculate the value of the constrained weight C is not necessarily limited to Formula (6) through Formula (9) for calculating the value of the constrained weight C such that a difference between H({σ^{\hat{ }}ᵢ}) and H({σ⁻ᵢ}) will become zero. Using Formula (16) instead of Formula (6), the coefficient setting unit 110 may calculate and update the value of the constrained weight C.

$${C}^{( n )} ← \frac{{H}_{p} ( \{ {σ}_{i}^{\hat{}} \} ) - {H}_{p} ( \{ {σ}_{i}^{-} \} ) + α}{{H}_{c} ( \{ {σ}_{i}^{-} \} )} \qquad ( 16 )$$

In Formula (16), α symbol α may be a certain constant having a predetermined value. For example, the value of α can be determined in advance with respect to each type of the optimization problem having a constraint condition to be solved by the computation apparatus 100. Alternatively, the coefficient setting unit 110 may calculate the value of α when calculating the value of the constrained weight C. For example, the coefficient setting unit 110 may calculate the value of a according to a ratio of the number of candidate solutions unsatisfying the constraint condition to the number of candidate solutions acquired by the solution acquisition unit 120.

When a has a positive value, the value H({σ^{\hat{ }}ᵢ}) after updating the value of the constrained weight C becomes larger than the value H({σ^{\hat{ }}ᵢ}) by α. When α has a negative value, the value H({σ^{\hat{ }}ᵢ}) after updating the value of the constrained weight C becomes smaller than the value H({σ⁻ᵢ}) by α.

The coefficient setting unit 110 may calculate and update the value of the constrained weight C according to Formula (17) instead of Formula (6).

$${C}^{( n )} ← \frac{β {H}_{p} ( \{ {σ}_{i}^{\hat{}} \} ) - {H}_{p} ( \{ {σ}_{i}^{-} \} )}{{H}_{c} ( \{ {σ}_{i}^{-} \} )} \qquad ( 17 )$$

In Formula (17), a symbol β may be a certain constant having a predetermined value. For example, the value of β can be determined in advance with respect to each type of the optimization problem having a constraint condition to be solved by the computation apparatus 100. Alternatively, the coefficient setting unit 110 may calculate the value of β when calculating the value of the constrained weight C. For example, the coefficient setting unit 110 may calculate the value of β according to a ratio of the number of candidate solutions unsatisfying the constraint condition to the number of candidate solutions acquired by the solution acquisition unit 120.

The value H({σ^{\hat{ }}ᵢ}) after updating the value of the constrained weight C is β times larger than the value H({σ⁻ᵢ}). When β>1, the value H({σ^{\hat{ }}ᵢ}) becomes larger than the value H({σ⁻ᵢ}). When 0<β<1, the value H({σ^{\hat{ }}ᵢ}) becomes smaller than the value H({σ⁻ᵢ}).

The computation apparatus 100 may use the constraint function H such that the value H_{c}({σ^{\hat{ }}ᵢ}) of the performance function H_{c} related to a candidate solution {σ^{\hat{ }}ᵢ} satisfying the constraint condition and minimizing the performance-function value becomes any value other than zero. When the value H_{c}({σ^{\hat{ }}ᵢ}) has a constant σ, for example, the coefficient setting unit 110 may calculate and update the value of the constrained weight C according to Formula (16). In this case, the value H({σ^{\hat{ }}ᵢ}) after updating the value of the constrained weight C becomes equal to the value H({σ⁻ᵢ}).

When a plurality of constrained weights is set to the constraint function H_{c}, the coefficient setting unit 110 may set each value of the constrained weight. For example, when the constrained weight is set to each constraint term (i.e., the term of the constraint function H_{c}), the coefficient setting unit 110 may set the value of the constrained weight for each constraint term. Herein, the verb “set” may embrace the verb “update” when interpretating the aforementioned techniques.

In the objective function H including the performance function Hₚ representing a performance for each candidate solution and the constraint function H_{c} representing a ratio of candidate solutions satisfying the constraint condition, the coefficient setting unit 110 may set the value of the constrained weight C for adjusting a degree of impact between the value of the performance function Hₚ and the value of the constraint condition H_{c} according to the value of the performance function Hₚ related to candidate solutions satisfying the constraint condition, the value of the performance function Hₚ related to candidate solutions unsatisfying the constraint condition, and the value of the constraint function H_{c}. The solution acquisition unit 120 may search for a solution to the optimization problem having the constraint condition to be solved using the objective function H having a setting of the value of the constrained weight C.

By adjusting the value of the constrained weight C according to the value of the performance function Hₚ related to candidate solutions satisfying the constraint condition, the value of the performance function Hₚ related to candidate solutions unsatisfying the constraint condition, and the value of the constraint function H_{c}, it is expected that the computation apparatus 100 can easily produce the optimum solution.

Now, we will study an excessively-weak degree of impact related to the constraint function H_{c} on the value of the objective function H. In this case, it is possible to consider that the solution acquisition unit 120 may preferably acquires a candidate solution having a small value of the performance function Hₚ irrespective of whether or not the candidate solution satisfies the constraint condition. However, it is possible to consider that a large ratio of the number of candidate solutions unsatisfying the constraint condition to the number of candidate solutions acquired by the solution acquisition unit 10 may reduce a probability of obtaining the optimum solution minimizing the value of the performance function Hₚ among all candidate solutions satisfying the constraint condition.

Now, we will study an excessively-strong degree of impact related to the constraint function on the value of the objective function H. In this case, it is expected that the solution acquisition unit 120 may easily produce candidate solutions satisfying the constraint condition, however, a weak degree of impact related to the performance function Hₚ in the objective function H may reduce a probability of obtaining the optimum solution among candidate solutions satisfying the constraint condition.

Specifically, a difference of the value of the objective function H between candidate solutions satisfying the constraint condition becomes relatively smaller than a difference between the value of the objective function H related to candidate solutions satisfying the constraint condition and the value of the objective function H related to candidate solutions unsatisfying the constraint condition. Accordingly, this may reduce a probability of obtaining the optimum solution minimizing the value of the performance function Hₚ among all candidate solutions satisfying the constraint condition with the solution acquisition unit 120.

On the other hand, adjusting the value of constrained weight C with the coefficient setting unit 110 may cause the solution acquisition unit 120 to easily produce candidate solutions satisfying the constraint condition, and therefore it is expected that a candidate solution having a relatively small value of the objective function H can be preferably selected from among candidate solutions satisfying the constraint condition.

In addition, the coefficient setting unit 110 can calculate the value of the constrained weight C even when the constraint condition includes a higher order of equality such as a quadratic equality or a higher order of inequality such as a quadratic inequality. Moreover, it is unnecessary for the coefficient setting unit 110 to produce an expected value for a certain term of the constraint condition for the purpose of calculating the value of the constrained weight C.

As described above, the computation apparatus 100 can adjust a degree of impact between the performance-indicator value and the constraint-indicator value so as to increase a probability of producing the optimum solution even when the constraint condition includes a higher order of equality such as a quadratic equality or a higher order of inequality such as a quadratic inequality or even when it is difficult to calculate an expected value for a certain term of the constraint condition. As described above, the value of the performance function Hₚ is an example of the performance-indicator value while the value of the constraint condition H_{c} is an example of the constraint-indicator value.

According to a candidate solution {σ^{\hat{ }}ᵢ} satisfying the constraint condition and minimizing the performance-function value and a candidate solution {σ⁻ᵢ} unsatisfying the constraint condition but minimizing the performance-function value among a plurality of candidate solutions, the coefficient setting unit 110 may re-set the value of the constrained weight C such that a difference of the value of the objective function H between those two candidate solutions becomes small after re-setting the value of the constrained weight C than before re-setting the value of the constrained weight C.

When the value of the objective function H related to a candidate solution {σ^{\hat{ }}ᵢ} satisfying the constraint condition and minimizing the performance-function value is excessively larger than the value of the objective function H related to a candidate solution {σ⁻ᵢ} unsatisfying the constraint condition but minimizing the performance-function value among a plurality of candidate solutions, a ratio of candidate solutions unsatisfying the constraint condition to all candidate solutions acquired by the solution acquisition unit 120 becomes large, thus reducing a probability of obtaining the optimum solution minimizing the value of the performance function Hₚ among all candidate solutions satisfying the constraint condition.

In this case, it is expected to increase a ratio of candidate solutions satisfying the constraint condition to candidate solutions each having a relatively small value of the objective function H acquired by the solution acquisition unit 120 when the coefficient setting unit 110 re-sets the value of the constrained weight C to reduce a difference between the value of the objective function H related to a candidate solution {σ⁻ᵢ} unsatisfying the constraint condition but minimizing the performance-function value and the value of the objective function H related to a candidate solution {σ^{\hat{ }}ᵢ} satisfying the constraint condition and minimizing the performance-function value. Accordingly, it is expected to increase a probability of acquiring the optimum solution with the solution acquisition unit 120.

When the value of the objective function H related to a candidate solution {σ⁻ᵢ} unsatisfying the constraint condition but minimizing the performance-function value is excessively larger than the value of the objective function H related to a candidate solution {σ^{\hat{ }}ᵢ} satisfying the constraint condition and minimizing the performance-function value among a plurality of candidate solutions, a difference of the value of the objective function H between candidate solutions satisfying the constraint condition become relatively smaller than a difference between the value of the objective function H related to a candidate solution satisfying the constraint condition and the value of the objective function H related to a candidate solution unsatisfying the constraint condition. Accordingly, it is possible to contemplate that a probability of the solution acquisition unit 120 to produce the optimum solution minimizing the value of the performance function Hₚ among all candidate solutions satisfying the constraint condition would be relatively low.

In this case, when the coefficient setting unit 110 re-sets the value of the constrained weight C to reduce a difference between the value of the objective function H related to a candidate solution {σ⁻ᵢ} unsatisfying the constraint condition but minimizing the performance-function value and the value of the objective function H related to a candidate solution {σ^{\hat{ }}ᵢ} satisfying the constraint condition and minimizing the performance-function value, it is possible to reduce a difference between the value of the objective function H related to a candidate solution satisfying the constraint condition and the value of the objective function H related to a candidate solution unsatisfying the constraint condition, and therefore it is expected to increase a probability of the solution acquisition unit 120 to produce the optimum solution.

Alternatively, the coefficient setting unit 110 may re-set the value of the constrained weight C such that the value of the objective function H related to a candidate solution {σ⁻ᵢ} unsatisfying the constraint condition but minimizing the performance-function value becomes identical to the value of the objective function H related to a candidate solution {σ^{\hat{ }}ᵢ} satisfying the constraint condition and minimizing the performance-function value.

This may eliminate the necessity of using a difference between the value of the objective function H related to a candidate solution {σ⁻ᵢ} unsatisfying the constraint condition but minimizing the performance-function value and the value of the objective function H related to a candidate solution {σ^{\hat{ }}ᵢ} satisfying the constraint condition and minimizing the performance-function value when the computation apparatus 100 calculates the value of the constrained weight C. In this point, the computation apparatus 100 bears a relatively small load of calculating the value of the constrained weight C with the coefficient setting unit 110, and therefore a time for calculating the value of the constrained weight C becomes relatively short.

In the above, the constraint function H_{c} is compulsorily set to a predetermined value when each candidate solution satisfies the constraint condition. The solution acquisition unit 120 may perform a solution search until detecting a candidate solution ascribed to the predetermined value of the constraint function H_{c} and a candidate solution ascribed to another value than the predetermined value of the constraint function H_{c}. The coefficient setting unit 110 may set the value of the constrained weight C according to the value of the performance function Hₚ related to a candidate solution ascribed to the predetermined value of the constraint function H_{c}, the value of the performance function Hₚ related to a candidate solution ascribed to another value than the predetermined value of the constraint function H_{c}, and the value of the constraint function H_{c}.

Accordingly, it is possible for the computation apparatus 100 to automatically acquire a candidate solution used for calculating an initial value of the constrained weight C. The present exemplary embodiment is advantageous in a small user's load since a user does not need to search for or calculate a candidate solution used for calculating an initial value of the constrained weight C.

The constraint function H_{c} is set to zero when each candidate solution satisfies the constraint condition. When the value H_{c}({σ^{\hat{ }}ᵢ}) of the constraint function H_{c} related to a candidate solution {σ^{\hat{ }}ᵢ} satisfying the constraint condition and minimizing the performance-function value is compulsorily set to zero, it is unnecessary for the computation apparatus 100 to use the value H_{c}({σ^{\hat{ }}ᵢ}) when calculating the value of the constrained weight C according to Formula (6). In this point, the computation apparatus 100 bears a relatively small load for the coefficient setting unit 110 to calculate the value of the constrained weight C, and therefore time for calculating the constrained coefficient C becomes relatively short.

The computation apparatus 100 may generate a plan. For example, the computation apparatus 100 may generate operation plans for factories. Specifically, the computation apparatus 100 may generate operation plans for factories to reduce costs such as material costs and running costs of factories as much as possible under constraint conditions such as the order of using devices when manufacturing products, the required time for each device, and target quantity of products.

In addition, the computation apparatus 100 may generate personal distribution plans. For example, the computation apparatus 100 may generate personal distribution plans to increase a performance for each person to achieve a desired result as much as possible under constraint conditions such as capability of each person, the required number of persons, an agreement on employment arrangements, and legal limitation.

In addition, the computation apparatus 100 may generate allocation plans of available frequency with radio base stations. For example, the computation apparatus 100 may generate allocation plans of available frequency with radio base stations to reduce call losses due to the nonexistence of available frequency as much as possible under constraint conditions such as preventing radio interference.

Moreover, the computation apparatus 100 may generate trading plans of financial products. For example, the computation apparatus 100 may generate trading plans of financial products to increase expected values of profits as high as possible under constraint conditions such as various types of information relating to tradable financial products and available funds.

The computation apparatus 100 may constitute a control device. In this case, the control device may generate a plan so as to control a control target according to the plan.

FIG. 18 is a block diagram showing a configuration example of a control system according to the exemplary embodiment. In the configuration shown in FIG. 18, a control system 2 includes a control device 200, and a control target 300. The control device 200 includes the coefficient setting unit 110, the solution acquisition unit 120, and the input/output unit 130 as well as a control unit 210. In FIG. 18, some parts having similar functions as the foregoing parts shown in FIG. 1 are denoted by the same reference numerals (e.g., 110, 120, 130), and therefore their detailed descriptions will be omitted here.

The control device 200 equipped with the control unit 210 differs from the computation apparatus 100 shown in FIG. 1. As to other parts except for the control unit 210, the control device 200 is similar to the computation apparatus 100. The control target 300 is not necessarily limited to specific ones; hence, it is possible to employ various items controllable according to plans. For example, the control target 300 may be a production system such as a factory; but this is not a limitation.

The control unit 210 is configured to control the control target 300 according to a plan related to the control target 300 which is acquired by the solution acquisition unit 120. For example, it is possible to determine an operation pattern of a control target constituting the minimum unit of a plan in advance, and it is possible to determine a control command for operating the control target 300 according to the operation pattern in advance. Subsequently, the solution acquisition unit 120 may generate a plan using a combination of operation patterns, and therefore the control unit 210 may output to the control target 300 via the input/output unit 130 a control command for operating the control target 300 according to the operation pattern indicated by the operation plan.

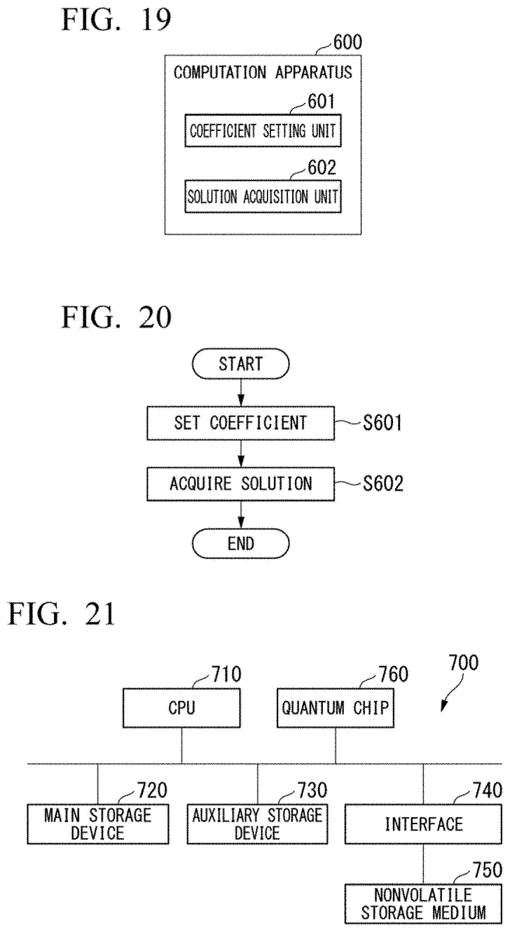

FIG. 19 shows another configuration example of a computation apparatus according to the exemplary embodiment. In the configuration shown in FIG. 19, a computation apparatus 600 includes a coefficient setting unit 601 and a solution acquisition unit 602. As to the objective function including a performance indicator representing the performance of a candidate solution and a constraint indicator representing a degree of the candidate solution satisfying the constraint condition, the coefficient setting unit 601 sets a value of coefficient for adjusting a degree of impact between a performance-indicator value and a constraint-indicator value in the value of the objective function according to a performance-indicator value related to a candidate solution satisfying the constraint condition, a performance-indicator value related to a candidate solution unsatisfying the constraint condition, and a constraint-indicator value. The solution acquisition unit 602 searches for a solution to a problem to be solved using the objective function which the value of coefficient is set to. In this connection, a coefficient for adjusting a degree of impact between a performance-indicator value and a constraint-indicator value will be referred to as an adjustment coefficient.

In the computation apparatus 600, it is expected to easily produce the optimum solution since the coefficient setting unit 601 is configured to adjust the value of the adjustment coefficient according to a performance-indicator value related to a candidate solution satisfying the constraint condition, a performance-indicator value related to a candidate solution unsatisfying the constraint condition, and a constraint-indicator value.

Now, we will study an excessively-weak degree of impact of a constraint-indicator value on the value of the objective function. It is possible to consider that the solution acquisition unit 602 may preferably acquire a candidate solution having a small performance-indicator value irrespective of whether or not the candidate solution satisfies the constraint condition. In this case, a ratio of candidate solutions unsatisfying the constraint condition to all candidate solutions acquired by the solution acquisition unit 602 will be increased, which in turn relatively reduces a probability of producing the optimum solution minimizing the performance-indicator value among all candidate solutions satisfying the constraint condition.

Next, we will study an excessively-strong degree of impact of a constraint-indicator value on the value of the objective function. In this case, it is expected that the solution acquisition unit 602 may easily acquire candidate solutions satisfying the constraint condition, however, a probability of acquiring the optimum solution minimizing a performance-indicator value will be relatively low due to a weak degree of impact of a performance-indicator value on the value of the objective function.

Specifically, a difference of the value of the objective function between candidate solutions satisfying the constraint condition becomes relatively smaller than a difference between the value of the objective function related to candidate solutions satisfying the constraint condition and the value of the objective function related to candidate solutions unsatisfying the constraint condition. Accordingly, the solution acquisition unit 602 may suffer from a relatively low probability of acquiring the optimum solution minimizing the performance-function value among all candidate solutions satisfying the constraint condition.

As described above, since the coefficient setting unit 601 is configured to adjust the value of the adjustment coefficient, it is possible for the solution acquisition unit 602 to easily acquire candidate solutions satisfying the constraint condition, and it is expected to preferably select a candidate solution having a relatively small value of the objective function among candidate solutions satisfying the constraint condition.

In addition, the coefficient setting unit 601 can calculate the value of the adjustment coefficient even when the constraint condition includes a higher order of equality such as a quadratic equality or a higher order of inequality such as a quadratic inequality. Moreover, it is unnecessary for the coefficient setting unit 601 to calculate an expected value relating to a certain term of the constraint condition for the purpose of calculating the value of the adjustment coefficient.

As described above, the computation apparatus 600 can adjust a degree of impact between a performance-indicator value and a constraint-indicator value so as to increase a probability of producing the optimum solution even when the constraint condition includes a higher order of equality such as a quadratic equality or a higher order of inequality such as a quadratic inequality and even when it is difficult to calculate an expected value related to a certain term of the constraint condition.

FIG. 20 is a flowchart showing a procedure example related to the calculation method according to the exemplary embodiment. The calculation method of FIG. 20 includes a step of setting a coefficient (step S601) and a step of acquiring a solution (step S602).

In the step of setting a coefficient (step S601), a computation apparatus may set the value of coefficient for adjusting a degree of impact between a performance indicator value and a constraint-indicator value in the value of the objective function, which includes a performance indicator representing performance for a candidate solution and a constraint indicator representing a degree of the candidate solution satisfying the constraint condition, according to a performance-indicator value related to a candidate solution satisfying the constraint condition a performance-indicator value related to a candidate solution unsatisfying the constraint condition, and a constraint-indicator value. In the step of acquiring a solution (step S602), a computation apparatus searches for a solution to a problem to be solved using the objective function which the aforementioned value of coefficient is set to. In this connection, the coefficient for adjusting a degree of impact between a performance-indicator value and a constraint-indicator value will be referred to as an adjustment coefficient.

According to the calculation method of FIG. 20, it is expected to easily produce the optimum solution since the computation apparatus is configured to adjust the value of the adjustment coefficient according to a performance-indicator value related to a candidate solution satisfying the constraint condition, a performance-indicator value related to a candidate solution unsatisfying the constraint condition, and a constraint-function value.

Now, we will study an excessively-weak degree of impact of a constraint-indicator value on the value of the objective function. In this case, it is considered that the computation apparatus may preferably acquire a candidate solution having a small performance-indicator value irrespective of whether or not the candidate solution satisfies the constraint condition. However, this may increase a ratio of candidate solutions unsatisfying the constraint condition to all the candidate solutions acquired by the computation apparatus, thus reducing a probability of acquiring the optimum solution minimizing the performance-indicator value among all candidate solutions satisfying the constraint condition.

Next, we will study an excessively-strong degree of impact of a constraint-indicator value on the value of the objective function. In this case, it is expected that a computation apparatus may easily produce candidate solutions satisfying the constraint condition, however, a probability of acquiring the optimum solution satisfying the constraint condition will become low due to a weak degree of impact of a performance-indicator value on the value of the objective function.

Specifically, a difference of the value of the objective function between candidate solutions satisfying the constraint condition becomes smaller than a difference between the value of the objective function related to a candidate solution satisfying the constraint condition and the value of the objective function related to a candidate solution unsatisfying the constraint condition. This may reduce a probability of the computation apparatus to acquire the optimum solution minimizing the performance-indicator value among all candidate solutions satisfying the constraint condition.

As described above, it becomes easy to acquire candidate solutions satisfying the constraint condition by adjusting the value of the adjustment coefficient with the computation apparatus, and therefore it is expected that a relatively small value of the objective function will be preferably selected from among candidate solutions satisfying the constraint condition. In addition, the computation apparatus can calculate the value of the adjustment coefficient even when the constraint condition includes a higher order of equality such as a quadratic equality or a higher order of inequality such as a quadratic inequality. Moreover, it is unnecessary for the computation apparatus to calculate an expected value related to a certain term of the constraint condition for the purpose of calculating the value of the adjustment coefficient.

According to the calculation method of FIG. 20, it is possible to adjust a degree of impact between a performance-indicator value and a constraint-indicator value so as to increase a probability of producing the optimum solution even when the constraint condition includes a higher order of equality such as a quadratic equality or a higher order of inequality such as a quadratic inequality, and even when it is difficult to calculate an expected value related to a certain term of the constraint condition.

FIG. 21 is a block diagram shoring the configuration of a computer according to the exemplary embodiment. In the configuration of FIG. 21, a computer 700 includes a CPU 710, a main storage device 720, an auxiliary storage device 730, an interface 740, a nonvolatile storage medium 750, and a quantum chip 760.

At least one of the computation apparatuses 100 and 600 or some parts thereof may be mounted on the computer 700. In this case, various functions or processes included in the computation apparatuses 100 and 600 can be realized by programs and stored on the auxiliary storage device 730. The CPU 710 reads programs from the auxiliary storage device 730 so as to deploy programs on the main storage device 720, thus executing the aforementioned processes according to programs. In addition, the CPU 710 may secure storage areas corresponding to the aforementioned storages on the main storage device 720. Communications between various devices and other devices can be implemented by the interface 740 having a communication function under the control of the CPU 710.

The quantum chip 760 is a chip (or circuitry) which may operate using quantum states in quantum mechanics. The quantum chip 760 performs annealing according to the foregoing operations of the foregoing embodiments. In this connection, the quantum chip 760 may be configured of a quantum device externally attached to the main body of the computer 700.

The computer 700 may execute quantum annealing by itself using the quantum chip 760 embedded therein. Alternatively, the computer 700 may execute quantum annealing via simulated annealing using the CPU 710.

When the computer apparatus 100 is mounted on the computer 700, the functions of the coefficient setting unit 110, the solution acquisition unit 120, and the input/output unit 130 can be realized by programs and stored on the auxiliary storage device 730. The CPU 710 may read programs from the auxiliary storage device 730 so as to deploy programs on the main storage device 720, thus executing the foregoing processes according to programs.

The CPU 710 may secure a storage area for the process of the computation apparatus 100 on the main storage device 720 according to programs. Communications between the computation apparatus 100 and other devices can be implemented by the interface 740 having a communication function under the control of the CPU 710. A user interaction with the computation apparatus 100 can be realized by a display device and an input device included in the interface 740, thus displaying various images on screen and receiving user operations under the control of the CPU 710.

When the computation apparatus 600 is mounted on the computer 700, the functions of the coefficient setting unit 601 and the solution acquisition unit 602 may be realized by programs and stored on the auxiliary storage device 730. The CPU 710 reads programs from the auxiliary storage device 730 so as to deploy programs on the main storage device 720, thus executing the foregoing processes according to programs.

In addition, the CPU 710 may secure a storage area for the process of the computation apparatus 600 on the main storage unit 720 according to programs.

Communications between the computation apparatus 600 and other devices can be implemented by the interface 740 having a communication function under the control of the CPU 710. A user interaction with the computation apparatus 600 can be realized by a display device and an input device included in the interface 740, thus displaying various images on screen and receiving user operations under the control of the CPU 710.

At least one or more parts of the foregoing programs can be stored on the nonvolatile storage medium 750. In this case, the interface 740 may read programs from the nonvolatile storage medium 750. Subsequently, the CPU 710 may directly execute programs read by the interface 740. Alternatively, the CPU 710 may temporarily store programs on the main storage device 720 or the auxiliary storage device 730 so as to execute programs thereafter.

Some or all functions to be performed by the computation apparatus 100 and 600 can be realized by programs and stored on computer-readable storage media; hence, a computer system may load programs stored on storage media so as to execute programs, thus achieving the foregoing processes. Herein, the term “computer system” may include hardware such as peripheral devices in addition to software such as an operating system (OS).

The term “computer-readable storage media” refers to flexible disks, optical-magnetic disks, ROM (Read-Only Memory), portable media such as CD-ROM (Compact-Disc ROM), storage devices such as hard disks embedded inside computer systems, and the like. The foregoing programs may achieve some of the foregoing functions, or the foregoing programs may achieve the foregoing functions when combined with pre-installed programs of computer systems.

Heretofore, the foregoing embodiments of the present invention have been described in detail, whereas concrete configurations should not be limited to the foregoing embodiments; hence, the present invention may embrace any modifications and design changes without departing from the essence of the invention as defined by the appended claims.

What is claimed is:

1. A computation apparatus comprising:
a coefficient setting unit configured to set, in a value of an objective function including a performance indicator representing performance of each candidate solution and a constraint indicator representing a degree of each candidate solution satisfying a constraint condition, a value of a coefficient for adjusting a degree of impact between a value of the performance indicator and a value of the constraint indicator according to a value of the performance indicator related to a first candidate solution satisfying the constraint condition, a value of the performance indicator related to a second candidate solution unsatisfying the constraint condition, and a value of the constraint indicator; and
a solution acquisition unit configured to search for a solution to a problem to be solved using the objective function which the value of the coefficient is set to.

2. The computation apparatus according to claim 1, wherein based on the first candidate solution satisfying the constraint condition and minimizing the value of the objective function and the second candidate solution unsatisfying the constraint condition but minimizing the value of the objective function among a plurality of candidate solutions, the coefficient setting unit is configured to re-set the value of the coefficient such that a difference of the value of the objective function between the first candidate solution and the second candidate solution becomes smaller after re-setting the value of the coefficient than before re-setting the value of the coefficient.

3. The computation apparatus according to claim 2, wherein the coefficient setting unit is configured to re-set the value of the coefficient such that the first candidate solution becomes identical to the second candidate solution in terms of the value of the objective function.

4. The computation apparatus according to claim 1, wherein the constraint indicator is set to a predetermined value with respect to a third candidate solution satisfying the constraint condition, wherein the solution acquisition unit is configured to perform a solution search until detecting the third candidate solution ascribed to the predetermined value of the constraint indicator and a fourth candidate solution ascribed to another value of the constraint condition than the predetermined value, and wherein coefficient setting unit is configured to set the value of the coefficient according to a value of the performance indicator related to the third candidate solution, a value of the performance indicator related to the fourth candidate solution, and the value of the constraint indicator.

5. The computation apparatus according to claim 1, wherein the constraint indicator is set to zero with respect to a third candidate solution satisfying the constraint condition.

6. A computation method comprising:
setting, in a value of an objective function including a performance indicator representing performance of each candidate solution and a constraint indicator representing a degree of each candidate solution satisfying a constraint condition, a value of a coefficient for adjusting a degree of impact between a value of the performance indicator and a value of the constraint indicator according to a value of the performance indicator related to a first candidate solution satisfying the constraint condition, a value of the performance indicator related to a second candidate solution unsatisfying the constraint condition, and a value of the constraint indicator; and
searching for a solution to a problem to be solved using the objective function which the value of the coefficient is set to.

7. A non-transitory computer-readable storage medium configured to store a program causing a computation apparatus to
set, in a value of an objective function including a performance indicator representing performance of each candidate solution and a constraint indicator representing a degree of each candidate solution satisfying a constraint condition, a value of a coefficient for adjusting a degree of impact between a value of the performance indicator and a value of the constraint indicator according to a value of the performance indicator related to a first candidate solution satisfying the constraint condition, a value of the performance indicator related to a second candidate solution unsatisfying the constraint condition, and a value of the constraint indicator; and
search for a solution to a problem to be solved using the objective function which the value of the coefficient is set to.
